(19) United States
(12) Patent Application Publication
(10) Pub. No.: US 2008/0295114 A1
(43) Pub. Date: Nov. 27, 2008

(54) Method and apparatus for execution control of computer programs

(76) Inventors: Pramod Vasant Argade, San Diego, CA (US); Shridhar Narayan Daithankar, Pune (IN)

Correspondence Address: PRAMOD VASANT ARGADE, 11471 RINGDOVE CORT, SAN DIEGO, CA, 92131, US

(21) Appl. No.: 12/151,626

(22) Filed: May 7, 2008

Related U.S. Application Data
(60) Provisional application No. 60/927,954, filed on May 7, 2007.

(51) Int. Cl. G06F 9/46

(52) U.S. Cl. 719/320

(57) ABSTRACT

A method for execution control of a user application program utilizing control program and management software is provided. This execution control is provided without a need to modify or recompile the user application program. The invention provides ability to save states during the execution of an application program and provides a means to jump between them. The invention also provides a means for multiple remote users to interact with the user program and also provide means to control the user application via script and share common portions of execution among multiple execution instances of the same user application program. The invention enables attaching a debugger to a state, maintaining debug context for all the saved states, and means to jump to a state saved at an earlier point in execution to help debug user application programs.

### REFERENCE TO PRIORITY DOCUMENT

This application claims the benefit of priority of co-pending U.S. Provisional Patent Application Ser. No. 60/927,954 entitled “EXECUTION CONTROL OF COMPUTER PROGRAMS”, Argade et al., filed May 7, 2007. Priority of filing date of May 7, 2007 is hereby claimed and the disclosure of the Provisional Patent Application is hereby incorporated by reference.

### BACKGROUND OF THE INVENTION

1. Field of the Invention

The present invention relates to computer processor operation and, more particularly, to run-time control of computer programs.

2. Description of the Related Art

A computer program is a collection of program statements, or instructions, that are executed by a processor of a computer system. There are many conditions under which it would be advantageous to have greater run-time control of program execution.

Computers are ubiquitous and have found numerous applications in diverse fields. However, there are four major problems with state-of-the-art software running on state-of-the-art computer hardware. First problem is that if a computer program crashes, due to software bug(s), there is no recovery mechanism in most cases. In such a case, valuable data and or time invested in running the program is lost and the complete program has to be rerun. Second problem relates to software development process, where finding and fixing “bugs” or errors in the programs is difficult and time-consuming process. Third problem is that if a program crashes intermittently, there is no easy mechanism to capture the entire stimulus that led to a particular crash. Finally, fourth problems is that even through a workload consisting of many instances of program execution may have exactly the same initial portions, there is currently no way of sharing these common portion of their execution to reduce overall program execution time for the workload. These and other problems with prior art way of running computer programs are discussed in detail below.

### Physical Systems Simulation

Engineering and scientific problems of physical systems are often solved with the aid of computer programs that simulate a physical condition under study. Such programs are run multiple times although the execution of initial portions of many such programs may be exactly identical.

### Social Systems Simulation

Computer programs are also used to simulate social systems, such as war games scenarios, disease propagation in a society, employment statistics for a national economy, and the like. Greater run-time control over the execution of the program could provide improved opportunity to study the effects of changes in parameters on the simulation results and could increase the efficiency of conducting multiple simulation runs.

### Fault Tolerance

There is no current methodology that guarantees that given software program will be bug free under all the operating conditions. Software programs routinely crash and valuable data as well as the investment in time and resources in running them are lost. It is desirable to recover from such a crash with minimal loss of effort/valuable data.

### Gaming Scenarios

Greater run-time control of a game program could enable a game player to save states and study successful and unsuccessful game strategies and tactics.

### Computer Program Development and Debugging

Any flaw in the program is referred to as a “bug.” Many tools are available in the market for software development. However, the debug process requires investigating program behavior back in time relative to the manifestation of the bug.

Execution of a program consists of processing instructions by the CPU. It is almost impossible to run the program backward. Since a computer program cannot be run backwards, the debugging process typically requires the software engineer to run the program multiple times from beginning in order to locate the code section with the error and then determine the needed correction.

Currently, the only practical solution to running a program backward is to save all the side effects of every instruction. The “Omniscient Debugging” technique uses this approach (e.g. http://www.lambdacs.com/debugger/debugger.html) which requires a large amount of data storage and considerably slows down the program execution speed.

Many debuggers are currently available, either free or for purchase. Examples are GDB (http://www.gnu.org/software/gdb) and Data Display Debugger (DDD, http://www.gnu.org/software/ddd). These debuggers generally provide a rich set of features to debug a program, such as, setting breakpoint/watch points, single stepping the program, etc. Recent version of GNU/GDB debugger (http://sourceware.org/gdb) provides a checkpoint/restart implementation. GDB debugger can save states, but is restricted to running programs that have been compiled with −g option. There is ongoing discussion on enhancing “reversible debugging” (http://sourceware.org/db/news/reversible.html) functionality in GDB. Furthermore, checkpoint/restart functionality is not designed for running end-user applications compiled without −g option.

“Efficient Algorithms for Bidirectional debugging” (SIGPLAN NOTICES ACM USA Vol. 35, no 5, May 2000, Pages 299-310) outlines a way for debugging forward and backward in time. The algorithms outlined require addition of voluminous calls to counter routines, which leads to reported 2-times slowdown in execution speed. The procedure outlined in this paper is restricted to debugging, is impractical for commercial applications and lacks most of the features outlined in the present invention.

Recently, a company named VirtueTech (http://www.virtutech.com) has introduced a product, called Simics Hindsight that enables running computer simulation in reverse. In order to use the tool offered by this company, special models of the processor have to be built.

Another company, named Green Hills Software, Inc. (http://www.ghs.com), has introduced a product that captures run-time trace from an embedded system. The trace data is coupled with the source code to help debug the programs.

### Constrained Run-Time Program Execution Environment

There are many facilities, such as fork a process, create pipes for communication, send signals to a process, handle signals received by a process, that are provided by a state-of-the-art operating system, such as GNU/Linux (http://www.kernel.org) and POSIX compliant operating systems. However, many programmers are not skilled in the art of programming using these system level facilities. Access to Operating System facilities must be incorporated in a program when it is designed. It is desirable to provide a run-time environment for a programmer and end-users that provides easy access to OS and other facilities.

It view of the foregoing discussion, it should be apparent that disadvantages in the conventional manner of running computer programs creates a need for improved run control techniques and tools. The present invention satisfies this need.

### SUMMARY

In accordance with the present invention, run-time control of an application program being executed by a computer system is obtained by executing a control program and management software from within an operating system of the computer apparatus. The computer system includes a processor unit that executes program code to provide an operating system environment within which the control program and the application program can operate.

In one aspect of the disclosed technique for controlling execution of an application program, execution of the control program is initiated, which creates a control process and execution of application program is initiated, which creates an application process which may be comprised of one or more threads of execution. Management software is loaded in the application process. The management software consists of exemplary functions for trapping one or more system calls made by the application process, handlers for signals received by the application process and functions to communicate with the control process. The control process sends control commands and/or signals to the application process and the management software processes them and sends response back to the control process. The control process communicates with the management software using various means of interprocess communication, such as, one or more pipes, network sockets and signals. Functionality of a control program may be integrated in the operating system, which may invoke it while running an application program and no explicit invocation of the control program may be required.

Execution of application program may initiate creating a plurality of instances of one or more, same or distinct application programs. In this situation, management software is loaded in each one of the resulting application processes and the management software in each one of the application processes communicates with the control program and processes control commands.

The management software supports processing of one or more commands. For example, a “spawn” control command processing in the application process results in spawning a child process which is an identical copy of the original parent application process, including a copy of the management software. After spawning, the parent or the child application process may continue execution or may be suspended. An application process may be viewed as a “state” of the application program at a point in execution. By using a spawn command, the control program may generate a plurality of states of the application program.

On a POSIX compliant operating system, the spawn command may be implemented using a “fork” system call which clones the parent process into a child process, including all input and output file descriptors. This ensures that each resulting process reads from one or more input files from the same offset. However, the resulting processes may write to the same output file thereby corrupting its contents. Consequently, the management software copies output files opened up to that point in time in execution and maintains them separately for each application process.

The management software traps an application process termination by a reason of normal or abnormal completion, and sends this change in application process status to the control program.

The control program provides means to suspend a state by sending it a suspend signal. Similarly, the control program may resume execution of a suspended state by sending a resume signal to it.

The control program optionally captures the console output generated by each application process in a memory buffer. Optionally, it provides console input to each application process.

The control program may be executed in interactive mode or batch mode. It provides a command line or graphical user interface to receive user commands and provide response to user commands. The control program processes the user commands locally or by converting them to control commands and sending them to one or more application processes for processing. The control program makes provision to run a script, for example, a TCL script, with means to issue user commands to the control program including means to provide console input to the application through the control program. Similarly, the script has provision to process the console output captured by the control program. These exemplary facilities enable a script to automate execution of an application program partially or completely.

The control program makes provision to be a server by opening a network socket or become a client by connecting to a network socket. This enables operation of the control program remotely over a socket. Furthermore, the control program as a network server can support multiple simultaneous network connections from clients, as well as clients connecting and disconnecting during a given control program session. Hence in a given session of the control program controlling execution of an application program, multiple users may interact with both of them simultaneously or serially.

Commercial versions of the control program has license mechanism built in which enforces how may instances of the control program may be in simultaneous use at a company site and the time period over which it may be use. The control program provides a user command and/or traps a signal sent to it to relinquish the license or regain the license.

The control program makes provision to connect a debugger to an application process and provides a user interface to control the operation of the debugger. A single instance of the debugger can be used to debug all the application processes by detaching the debugger from one process and attaching it to another process. Furthermore, the control program saves debug context, comprised of exemplary breakpoint, watch point and display variables associated with each state. Since the management software prevents operating system from purging an application process upon termination, a debugger can be attached to such a process to debug the cause of termination or to recover any valuable input stimulus or data generated by the application process. The overall debugging of user application process can be partially or fully automated by running a script on the control program.

The control program creates a higher level of abstraction for executing application programs and providing control over the application processes at run time. For example, it provides user commands to start execution of an application program and create a plurality of application processes using spawn command. Furthermore, it presents this plurality of application processes as states of the application program at various points in execution via exemplary view in which each state has a serial number, editable name and descriptive note. An exemplary “jump” user command suspends execution of current state and resumes execution of a target state, thereby creating an illusion of jumping forward or backward in time in execution within a program instantaneously. This abstraction further provides means to connect a debugger to any state and maintain state-specific debug context.

The abstraction further creates an illusion of providing functionality run time that is not built into the original user application. For example a script running on the control program can effectively automate running of the user application. One or more remote users can interact with and control a user application simultaneously or serially. Multiple runs of the same user application can share initial common portions of execution by cloning a state and providing a different stimulus to the remaining execution of the child application process and parent application process. An illusion can be created of letting a user interact with a program running in batch mode. This is done by running the user program in interactive mode under the control of the control program running in batch mode and another instance of the control program connecting with the control program in batch mode over a network socket at any time.

The method of in this invention controls user application program without any need to modify or recompile it. Furthermore, the user application process executes at its native speed while it is not executing control commands. In a typical scenario, the control process occasionally sends control commands to an application process and the management software typically processes these commands in relatively short amount of processing time. As a consequence, a user application running under the control of the control program has a very small time overhead. Furthermore, control of application program is achieved with preservation of the application program behavior. By “application program behavior” is meant the way in which an application program operates in terms of responses to any input stimulus and any output that is produced by the application program.

An exemplary computer apparatus based on the present invention is comprised of hardware and an operating system and a user interface wherein control program controls execution of an application program using the management software.

An exemplary product based on the present invention is comprised of a recordable media including the control program and management software, which when installed on a computer system can control a user application as described.

These and many other novel features of the present invention result in a new approach to running and debugging user application programs, which is not anticipated, rendered obvious, suggested or even implied by any of the prior art ways of running and debugging user application programs, either alone or in any combination thereof.

There has thus been outlined features achieved with the invention in order that the detailed description thereof may be better understood, and in order that the present contribution to the art may be better appreciated. There are additional features in accordance with the invention that will be described hereafter. In this respect, before explaining embodiments of the invention in greater detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed here are for the purpose of the description and should not be regarded as limiting. These and other features and advantages of this invention are described in or are apparent from the following detailed description of the preferred embodiments.

### BRIEF DESCRIPTION OF THE DRAWINGS

Preferred embodiments of this invention will be described in detail, with references to the following figures, wherein:

FIG. 1 shows a typical desktop computer system, generally useful with an embodiment of the present invention.

FIG. 2 shows a schematic of printed circuit board, also called motherboard, inside a typical computer system, generally useful with an embodiment of the present invention.

FIG. 3 shows conventional user application program execution (“UserApp”).

FIG. 4 is a block diagram showing an embodiment of the present invention as a “Virtual Parallel Universe Link” (“ViPUL”) and its interaction UserApp, Management Software (“MgmtSW”) and an operating system.

FIG. 5 is a functional block diagram showing an exemplary embodiment of the present invention.

FIG. 6 is a block diagram showing interaction between ViPUL and UserApp as well as execution of UserApp under the control of ViPUL according to an embodiment of the present invention.

FIG. 7 shows an exemplary snapshot of Graphical User Interface (GUI) of ViPUL.

FIG. 8 shows program listing of an application program written in C++, useful with the description of the present invention.

FIG. 9 shows exemplary pseudo-code implementing some aspects of the present invention.

FIG. 10 shows exemplary pseudo-code for an exemplary MgmtSW function that initializes interaction between UserApp and ViPUL, in accordance with an embodiment of the present invention.

FIG. 11 shows UserApp and ViPUL interacting with each other via named pipes according to an embodiment of the present invention.

FIG. 12 shows exemplary pseudo-code in ViPUL that runs a debugger and attaches it to the UserApp, in accordance with an embodiment of the present invention.

FIG. 13 shows exemplary pseudo-code in ViPUL that is responsible for interacting with a debugger.

FIG. 14 shows UserApp, ViPUL, the debug module in ViPUL and a debugger interacting via named and unnamed pipes according to an embodiment of the present invention.

FIG. 15 shows an example list of commands implemented by ViPUL according to the present invention.

FIG. 16 shows exemplary state table and associated widgets in ViPUL GUI.

FIG. 17 shows listing of a TCL script program to control example UserApp shown in FIG. 8, in accordance with an embodiment of the present invention.

FIG. 18 is an exemplary graphical representation of how an embodiment of the present invention is used to share common execution portions of UserApp while running a workload consisting of running multiple instances of UserApp.

### DETAILED DESCRIPTION

The present invention provides additional virtual capabilities to the user application program (“UserApp”) at run time that are not built into the original application program. In computer systems, “virtual” refers to illusion created within the framework of the computer system. The present invention may be implemented as control program (“the control program”) and the UserApp is run under its control. Alternatively, the functionality of the control program may be integrated into the operating system.

We describe the present invention by outlining the implementation of the control program. It makes use of various facilities provided by an operating system. For illustration purposes, we will identify various facilities available in GNU/Linux and POSIX compliant operating systems (http://www.kernel.org) to implement the present invention. It may be implemented on other Operating Systems by using combination of similar facilities available and/or by writing library functions to provide missing facilities.

Most of the users of a computer system typically use programs developed by commercial software vendors and cannot modify such programs once delivered. A small portion of users of computer systems develops their own programs. However, there are generally practical constraints in modifying user's own code. Given these constraints for UserApps, the present invention has been designed such that it can control UserApps without any need to modify them.

One example mechanism to accomplish this is based on use of an environment variable. User of a computer system can set an environment, which can then be optionally used by a UserApp to configure itself. For example, GNU/Linux OS provides an environment variable, LD_PRELOAD. It can be set to specify complete path to a shared library (“preload library”), which is a “.so” image. If this variable is set while executing UserApp, the operating system creates a UserApp process and loads the preload library before starting execution of the actual UserApp, which typically involves calling function called “main.” Furthermore, GNU/GCC compiler provides_attribute_((constructor)) and_attribute_((destructor)) function attributes to specify, respectively, function to call on initialization (i.e. when the program is about to start execution) and cleanup (i.e. when the program is about to exit).

In general, preload library is used for interposition of standard library calls, i.e. to provide additional functionality (See, for example, http://developers.sun.com/solaris/articles/lib_interposers.html). In the present invention in addition to interposition of standard library calls, we extend the use preload library for tasks, such as, to process control commands and provide signal handlers. We will refer to the preload library designed according to the present invention as “Management Software” (“MgmtSW”).

According to the present invention, end user is provided with the control program and a MgmtSW image consisting of compiled routines for constructor and destructor routines mentioned above as well as other helper routines designed according to the present invention. The control program uses LD_PRELOAD environment variable and a function specified as “constructor” in the attribute above to call an initialization function in MgmtSW to establish communication channels between the control program and the UserApp just before the UserApp starts execution. If a computer system does not have a facility similar to LD_PRELOAD, an explicit call to the initialization function needs to be placed in the initialization portion of the UserApp and the library supplied with the control program may be linked with the UserApp. A U.S. pending patent application Ser. No. 11/375,494 “ENVIRONMENT FOR RUN CONTROL OF COMPUTER PROGRAMS” by first authors of the present application takes this approach.

The control program executes UserApp in a child process. The initialization function mentioned above sets up one or more signal handlers. Signal is a facility provided by an operating system to interrupt execution of a program at an arbitrary point. A program may send signal to another program by using a system call such as “killo”, which takes as parameters the process ID and the signal number to send to the target program. In the initialization function a specific function may be associated with a specific signal. When a program receives a specific signal, it interrupts the execution of program flow and the function associated with that signal is called. The control program uses this mechanism to control the execution of UserApp.

The control program provides a Command Line Interface (CLI) as well as Graphical User Interface (GUI) for a user to interact with. User utilizes these interfaces to give commands, such as, spawn state, suspend state, wake up state, etc to the control program. During the execution of the initialization function, inter-process communication is established between UserApp and the control program by using one or more “pipes.” The control program converts user commands mentioned above into internal commands, interrupts UserApp by sending a signal and sends the command to the signal hander via pipe. In turn, UserApp sends acknowledgment, other information and completion message to the control program via another pipe. This mechanism gives a user control over execution of the UserApp at run-time. The control program optionally provides ability to run a debugger and establish inter-process communication with it. User may then request that this debugger be attached to the UserApp process and the control program can be used to control the execution of UserApp using the control program commands as well as the debugger commands. Since the control program uses signals to control the execution of UserApp, a user can control execution of UserApp at any arbitrary point in execution.

The control program provides a set of commands for controlling the execution of UserApp, such as, spawning a state (i.e. creating a child process), by forking a child process, jumping to another state by pausing one state and waking up another state, etc. When a clone state is spawned from a given state using a fork system call, two parallel universes are created in which parent and child states continue to run an instance of the program. The program provides the ability to not only create multiple parallel universes but also ability to jump between them, and thus provides a link between the created universes.

We refer to the software built according to the present invention in an exemplary embodiment as Virtual Parallel Universe Link (ViPUL), and the “MgmtSW” built according to the present invention as “MgmtSW.” Note that MgmtSW runs along with and in address space of UserApp.

A user typically purchases commercial UserApps and the vendor typically imposes restrictions on how many UserApps may be run at a given point in time at the customer site. Providing ability to spawn multiple states and letting them execute in parallel may enable a user to violate these restrictions. ViPUL provides hooks for gaining a license every time a new state is created and also a provision to give up a license when a state is deleted or suspended.

It is noted that the present invention is applicable to any computer system, such as, desktop, mainframe, embedded, etc.

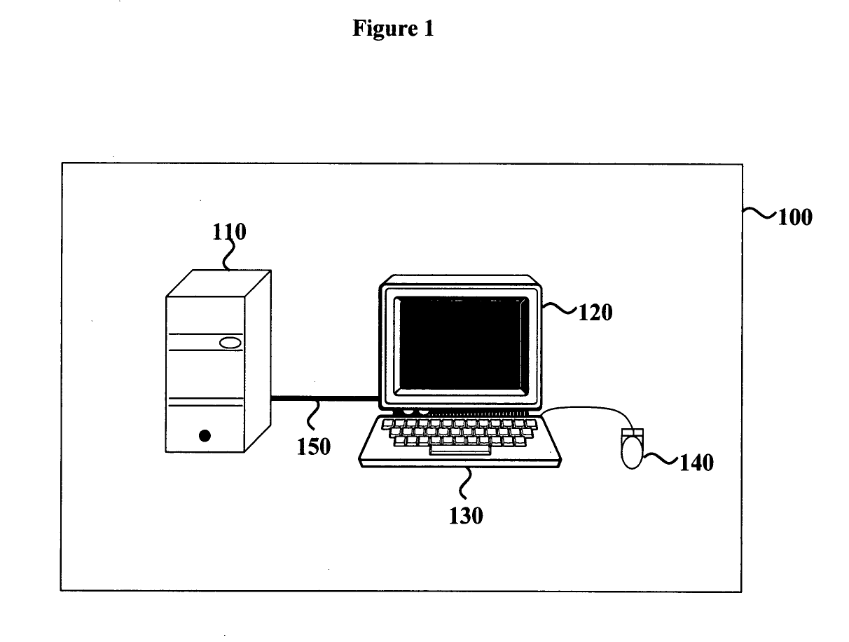

FIG. 1 shows a typical desktop computer system (100). It consists of an enclosed box (110) that typically contains one or more printed circuit boards populated with integrated circuits. It also typically contains a power supply and peripherals, such as, Compact Disk (CD), Digital Video Disk (DVD), and connectors for peripherals, such as, Universal Serial Bus (USB) devices, keyboard (130), mouse (140), monitor (120), cable (150) for monitor, keyboard as well as mouse and printer (not shown).

The computer system 100 includes an Operating System (OS) program that controls the working of the computer system, including managing access to computer resources, receiving commands from the user and running application programs. Those skilled in the art will also appreciate that the computer system could be implemented as an embedded system, in which the computer controls the operation of a device, such as a control system in an automobile, with minimal, if any, interaction from the user. Such systems are increasingly making use of real-time OS in their operation. For example, real-time Linux is available from a company called Montavista (http://www.mvista.com)

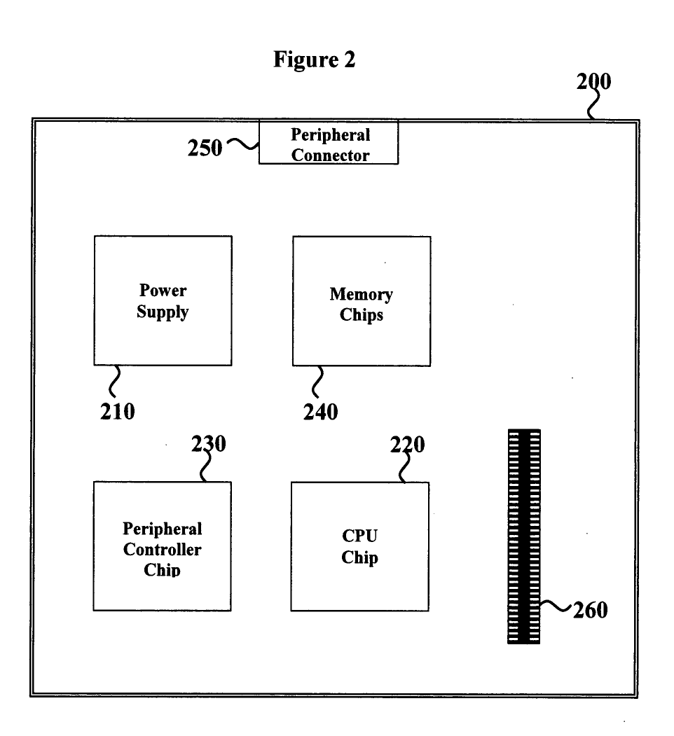

FIG. 2 shows a computer motherboard (200), which is a printed circuit board with multiple layers for interconnecting components mounted on the surface. Example components of the motherboard component (200) in the system 100 include a CPU Chip (220), Peripheral Controller Chip (230), Power Supply (210), Memory Chips (240) and Peripheral Connector (250). The motherboard can also have one or more socket (260) into which a daughter card may be plugged in. Various chips on the motherboard contain logic required to run the OS as well as application programs.

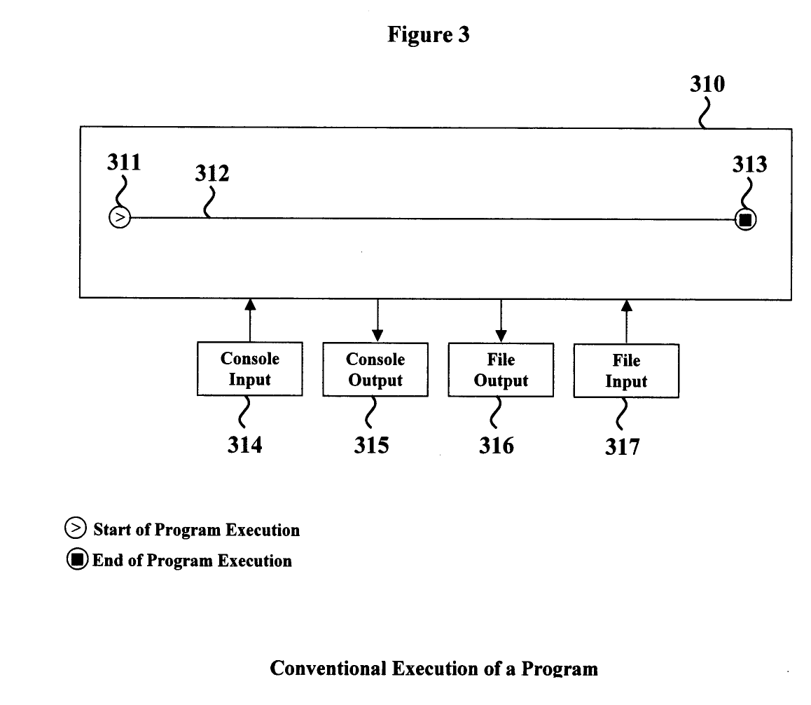

FIG. 3 shows conventional execution of a program. A conventional user application (310) starts execution (311) and continues execution for a certain amount of time represented by time-line segment 312 and ends (313). Once a conventional program execution has started, it can only proceed forward in time using at most one set of input parameters. A user may optionally provide input to the UserApp (310) via console input (314), receive output to console (315), provide input to the UserApp via one or more files (317) and receive output from the program in one or more files (316).

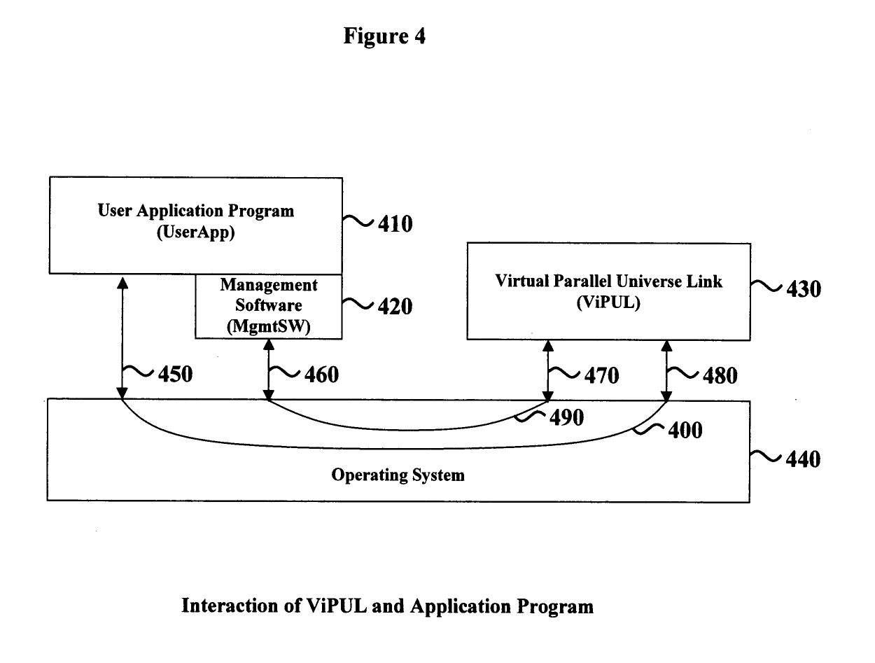

FIG. 4 shows how a user application “UserApp” (410) is run under the control of a program, build in accordance with an embodiment of the present invention we will refer to as “Virtual Parallel Universe Link”, or “ViPUL” (430). A user starts execution of ViPUL (430) and instructs it to control the execution of UserApp (410) by specifying it as a command line parameter. ViPUL processes optionally specified command line arguments, environmental variables and configuration files and sets up internal data structures. It sets up process ID of ViPUL an environment variable “ViPUL_PID” to help the initialization function in the MgmtSW (420) determine the name of the named pipe described below. ViPUL sets up multiple threads to provide non-blocking execution of various functions of ViPUL. Subsequently, ViPUL (430) opens one or more pipes (480) using “pipe” system call, opens one or more named pipes (470), also referred to as FIFO, using “open” system call and makes a “fork” system call to create a child process. In the parent process, ViPUL continues execution, while in the child process, UserApp (410) is executed using “exec” system call.

An initialization function in the MgmtSW (420) with attribute “constructor” gets executed due to the LD_PRELOAD environment variable described above. Using environment variable “ViPUL_PID” set by ViPUL as mentioned above, the initialization function in the library (420) opens one or more named pipe (460). OS (440) provides facilities (490) to connect pipes 460 to/from UserApp and pipes 470 from/to ViPUL (430). These pipes are used to communicate commands and information between ViPUL and UserApp in the signal handlers described below.

The initialization function (420) also sets up multiple signal handlers, which become part of the UserApp. For example, GNU/Linux OS provides signals “SIGUSR1” and “SIGUSR2” for use by the application. When SIGUSR1 is delivered to UserApp (410), the signal handler associated with it gets called asynchronously with the execution of UserApp. In one exemplary embodiment of the present invention, ViPUL uses SIGUSR1 and SIGUSR2 to communicate asynchronously with UserApp (410), and available signals may be used for this purpose. In addition, ViPUL sets up other signal handlers if requested by the user when ViPUL is started. An example of such a signal is “SIGSEGV” which is raised by the OS if program accesses memory with an invalid memory address.

A typical application receives input from the console (“STDIN”), and sends output to console (“STDOUT”) and error output to the console (“STDERR”). This input/output (“I/O”) is referred to as “STDIO.” When ViPUL (430) is started, the user may specify that ViPUL should display STDIO in the GUI and in addition make the STDIO available via TCL script running on ViPUL. To provide this functionality, ViPUL connects STDIO (450) from the child process to pipe 480 using one or more “dup2” system calls. The OS provides a mechanism (400) to connect STDIO (450) to the pipe (480).

In addition to STDIO, UserApp (410) may receive input data from one or more files and write output to one or more output files. As described below, ViPUL (430) may generate multiple instances of UserApp (410). Furthermore, under user control, each one of these instances may execute part of the way before another instance is activated to proceed forward. GNU/Linux operating system provides services whereby if a file has been opened by UserApp for reading then multiple instances created as child processes read from the input file at the correct location. However, if UserApp opens a file for output, multiple instances may write to the same output file, thereby corrupting the output file.

ViPUL uses interposition of system calls via MgmtSW to manage output files on a per process basis. A UserApp typically opens a file for output by using a system call, such as, “open” system call. However, MgmtSW (420) is loaded before the standard system supplied library. Thus, if this library provides a function, such as, “open” then it is executed instead of the one in the standard system supplied library. Thus, operating system “open” call is redirected to the ViPUL supplied “open” function call.

The ViPUL supplied “open” function call analyzes the parameters of “open” system call and records whether an output file or input file is being opened. If an output file is being opened, it records the name of the file. The MgmtSW has the state number as one of the global variables, which is set by ViPUL during initialization to zero. Subsequently, when a state is created by a “fork” system call, ViPUL sends a command via pipe 470 to set the new state number for the child process. Similarly, while jumping from one state to another state, a command is sent to the current state over pipe 470 to suspend it. For the target of the jump, a signal is sent to take it out of the suspend state. Thus, a variable is available in each state to determine its state number.

Consider a case where UserApp wants to open an output file “xyz.dat” while it is in state “N.” In this case the ViPUL supplied “open” function modifies the file name to “xyz_N.dat” and calls the standard library call with this name. It also notes the root name (in this case “xyz.dat”) for each output file and the file descriptor “D” returned by the “open” system call to the application. When ViPUL sends a command to state N to do a “fork” system call, the routine first checks whether any output files are open. For each output file, the current size in bytes is noted and each output file is copied to corresponding name. For example, if the new state number is “M”, “xyz_M.dat” file is opened with the “open” system call, and the file descriptor “E” with this “open” call is noted. Subsequently, the old file descriptor “D” associated with xyz_N.dat is closed and is instead is instead attached to the file descriptor “E” using “dup2” system call. All the output of “xyz_N.dat” up to that point in time is copied to “xyz_M.dat.” From that point on, state “M” continues to write to descriptor “D,” but the output goes to “xyz_M.out.” In order to prevent output files from multiple states from being generated in the same directory, ViPUL generates a separate directory with a name consisting of information, such as, the state number and time stamp and maintains the all the output files from a given state in that directory. End of file io section to move.

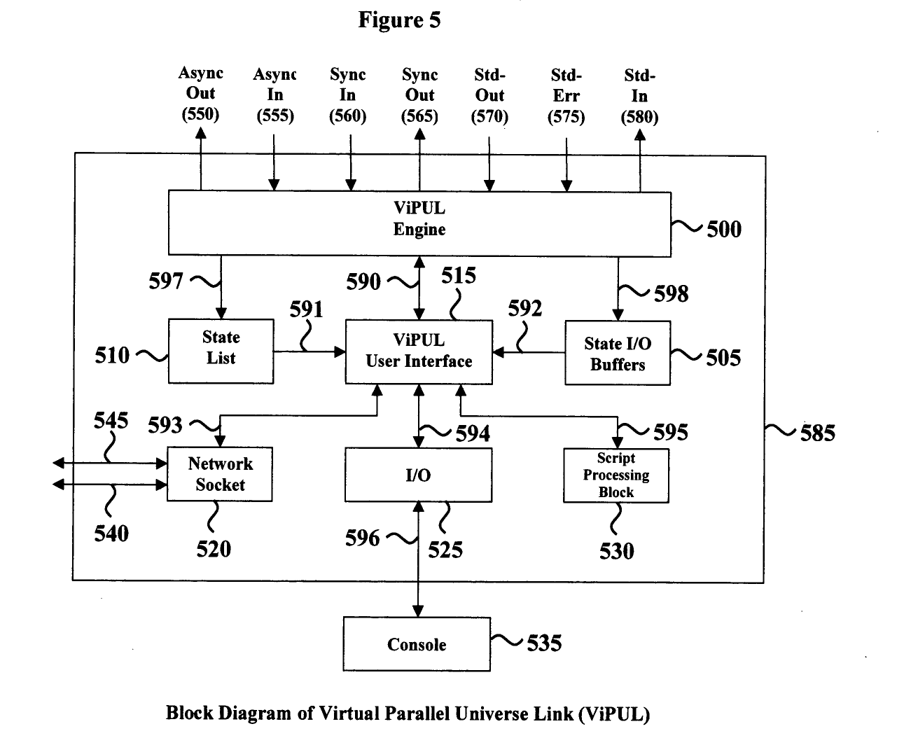

FIG. 5 shows a block diagram of ViPUL (585). It is comprised of ViPUL Engine (500), ViPUL User Interface (515), State List (510), State I/O Buffers (505), I/O (525) that is connected to a Console (535), Network Socket (520), two example connections (540, 545) to the Network Socket from two clients and Script Processing Block (530).

In order to provide non-blocking functionality, ViPUL User Interface (515), ViPUL Engine (500) and Script Processing Block (530) are run in separate threads. ViPUL User Interface (515) manages Graphical User Interface or Command Line Interface, processes command-line parameters, as well as configuration files that specify ViPUL configuration parameters, interacts with the user via Input/Output (525, 594, 596) to Console (535) and sends user commands as well as internally generated commands to the ViPUL Engine (500) via internal data structures (590). It displays State List (510, 591), status of Network Socket (520, 593), progress of user commands and the script (530, 595) on the Console (535), either in graphical or command line mode.

ViPUL Engine (500) receives commands from ViPUL User Interface (515) and sends responses to these commands as well as asynchronous status to ViPUL User Interface via internal data structure (590). ViPUL engine is responsible for starting the execution of UserApp and for interfacing with it, as described above. ViPUL Engine (500) has following pipes connected to UserApp: Asynchronous Out (550), Asynchronous In (555), Synchronous In (560), Synchronous Out (565), Standard Out (570), Standard Error Out (575), Standard In (580). These pipes are equivalent to the pipes 470/460 and 480/450 shown in FIG. 4.

Pipe Asynchronous Out (550) is used by ViPUL Engine (500) to send commands to UserApp after sending it SIGUSR1 or SIGUSR2. Pipe Asynchronous In (555) is used by UserApp to send response to ViPUL Engine. Synchronous Out (565) is used by ViPUL Engine to send commands synchronously to UserApp and pipe Synchronous In (560) is used by UserApp to send responses to synchronous commands to ViPUL Engine. Pipes 570 and 575 are optionally used by UserApp to send STDOUT and STDERR data, respectively, to ViPUL Engine and pipe 580 is optionally used by ViPUL Engine to send STDIN to UserApp. Pipes 570, 575 and 580 are used when the user specifies that ViPUL should control STDOUT, STDERR and STDIN respectively, either via command line parameter or in a configuration file.

Pipes Synchronous Out (565) and Synchronous In (560) are used by ViPUL to send and receive command and responses between UserApp and ViPUL when UserApp inserts calls to specific library functions in MgmtSW to signal occurrence of specific events. This obviously requires modification of the UserApp source code and recompilation. This approach of UserApp control may be used if the application does not communicate with the user at run-time via STDIO, and expects ViPUL to control it at run-time. It does this by signaling to ViPUL occurrence of a special event, such as starting another iteration of a loop inside a program, and expects the user or a script running on ViPUL to take a specific action.

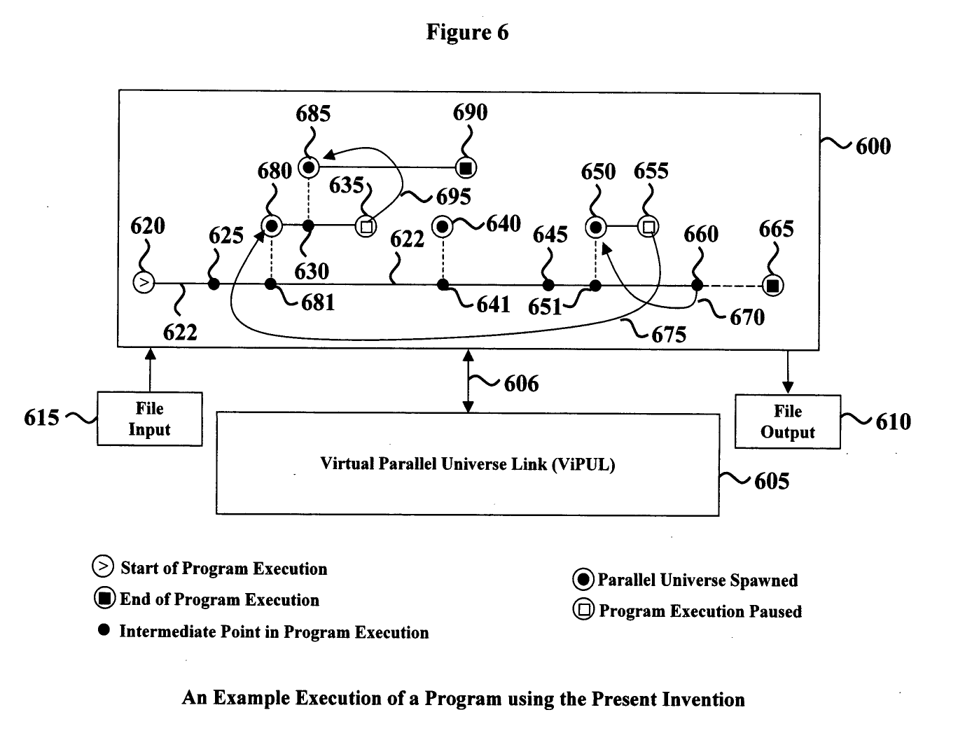

FIG. 6 shows how ViPUL (605) controls the execution of UserApp (600) according to the present invention. ViPUL (605) is equivalent to 585 in FIG. 5. 606 represents pipes 550, 555, 560, 565, 570, 575 and 580 in FIG. 5 which are described above. UserApp (600) may read input from one or more file (615) and may write output to one or more file (610).

ViPUL starts execution of the UserApp (620) which proceeds forward in time, as represented by line segment 622. If run in a conventional way, the program would complete execution at 665. According to the present invention, a user gains run-time control over the execution of UserApp via ViPUL. Note that this ability to control the execution of UserApp is in addition to and distinct from the ability UserApp may offer the user via built-in features, such as, waiting for input. According to the present invention, user can decide how long the program runs before taking the next course of action. Example intermediate points 681, 630, 645 and 660 within the application program execution are points where the execution is halted temporarily. ViPUL can temporarily halt the execution of UserApp by sending a signal and sending a command to wait for next command. The intermediate point may be programmed in ViPUL to be determined by temporal progress of the application program (i.e., subject to wall clock time) or based on an event in the application program, such as, request for user input. Another situation is when a debugger is attached, in which case the intermediate point may be when a breakpoint is reached.

At an intermediate point, the application program is suspended and the user can specify a variety of commands to ViPUL via user interface. One of the commands is to clone (i.e. save state) which is to spawn a Parallel Universe by creating an identical instance of the application program process at that particular point in the program execution by creating a child process using “fork” system call. For example, FIG. 6 shows following pairs of (intermediate point, creation of identical instance): (681, 680), (641,640), (651, 650) and (630, 685). Once an identical instance is created, such as 685 from 630, the user can control further execution of that instance, from 685 to 690, by providing the same additional inputs as provided to advance the process 680 from point 630 to 635, or different inputs. This underscores the fact that states 680 at intermediate point 630 and state 685 are truly parallel universes where the user controls whether they will advance along identical execution paths or along different execution paths. Additionally if the userApp is multithreaded, all the threads in the application needs to be restarted after creating a new process, since with fork( ) only the calling thread is duplicated. A POSIX compliant system offers a pthread_atfork( ) system call, which may be used to synchronize all the threads before the fork system call is executed and for re-creating all the threads in the child process created by the fork system call.

One of the options to the user at an intermediate point, via ViPUL, is to pause the current state, by using “sigsuspend” system call, at that particular point in time and jump to another paused instance by sending it a signal to exit from the “sigsuspend” system call. This process of jumping takes very small amount of processor execution time and appears instantaneous to the user. Furthermore, ViPUL provides ability to jump to any paused state, either forward or backward in time relative to the current state. This creates an illusion of a time machine and we also refer to ViPUL as Virtual Time Machine (VTM). ViPUL helps create an illusion to the user of creating multiple parallel universes on demand and a link between them, i.e. ability to jump between them.

In the example execution using the present invention as illustrated in FIG. 6, after states as described above, the user instructs ViPUL to pause the application program execution at an intermediate point 660 and jump to the state paused at 650, conceptually shown via arrow 670. The user then instructs to advance this state to 655, pause it and jump to state 680, shown via arrow 675. This state is then instructed to advance to 630, at which point a new state 685 is spawned and paused. Execution of state 680 then continues from point 630 to 635, at which point this state is paused. The user then instructs ViPUL to jump to state 685, shown via arrow 695. This state is instructed to advance to 690 at which point the execution of state 685 completes.

The execution may complete at point 690 for various reasons. Example cases are: UserApp called “exit” function which indicates completion of the program to the operating system. MgmtSW (420, FIG. 4) provides an exit function, which overrides the exit function provided by the standard system library. This function sends a message to ViPUL indicating that the current state has called the exit function and is about to end. ViPUL then informs the user of this fact by marking specially labeling the state as having exited, optionally printing a message on the user interface and by setting appropriate variables accessible to the script.

Another example reason the execution of UserApp may complete at point 690 is because the UserApp encountered an exception condition, such as, floating point divide by zero exception. In this case, the operating system sends a special signal SIGFPE. As described before, the initialization function in MgmtSW (420, FIG. 4) installs, if specified by the user, handler for signal SIGFPE. Thus, when process 685 receives SIGFPE signal at point 690, the corresponding handler function is called. This function informs ViPUL that UserApp in state 685 has generated SIGFPE exception. ViPUL in turn informs the user of this fact or provides TCL scrip (530, FIG. 5) this information. The user or script may provide further instructions to ViPUL about the next course of action. One example course of action supported by ViPUL is for the user to request that a debugger, such as, GDB be attached to state 685 at point 690 to determine the reasons where in the code and why the exception was generated. Another example course of action is for the user to instruct ViPUL to jump to one of the spawned states which is in a paused state and continue execution for it.

Note that user may generate multiple states as UserApp is running, but may not utilize all the states, or run all the states to completion. For example, in FIG. 6, State 640 is created at point 641 in execution, but is not utilized. When user instructs ViPUL to exit, all the open files are closed and all processes corresponding to the states are killed by sending SIGKILL signal to them.

ViPUL provides ability to jump either backward in time (for example from 655 to 680) or forward in time (for example from 635 to 655, arrow not shown in FIG. 6). The dotted line between a state (e.g 681) and a created identical state (e.g. 680) only indicates that the two states are identical in terms of temporal and functional state of program execution and that 680 was generated from 681 by using “fork” system call.

Note that when “fork” system call is used to create a child process, all the open file descriptors are duplicated. Furthermore the child process inherits the file offset for each one of the file descriptors. Thus, if UserApp (600) has read some data from input file (615), both the parent and child processes will continue to read from the same offset when execution continues. In the case of output file (610) also the file descriptor is duplicated and both parent and child processes will continue to write to the same file. This may lead to duplicate output in the output file. In order to avoid this, MgmtSW overrides “open” system call and maintains separate output files for each state as described below.

We note that using LD_PRELOAD mechanism described above, applications can be run under the control of ViPUL without any modifications. Furthermore, only time ViPUL interrupts the execution of UserApp is when it has to send a command, to it and receive response from it. This overhead is very small. Thus, if ViPUL is not sending any commands to UserApp, there is no impact on the execution speed of UserApp. When ViPUL sends a “clone” command to UserApp, which results in “fork” system call, it takes a few microseconds, which is negligible if the time interval between saving states is in measured in seconds or more. Furthermore, “fork” system call is used to clone states. On GNU/Linux OS, fork uses “copy on write” mechanism, which delays copying memory and other data structures until a process does a write to that memory. Consequently, the storage requirements for each extra state created is small.

ViPUL uses multiple threads to provide non-blocking behavior. Furthermore, ViPUL engine, which runs in a separate thread, interfaces with multiple entities, such as, ViPUL user interface, UserApp signal pipes, STDIO from UserApp, debugger, etc. In order to ensure non-blocking behavior, ViPUL uses “poll” system call to monitor whether above entities are ready for input or output.

Tool Command Language (TCL, see http://tcl.sourceforge.net) is a powerful scripting language intended to be embedded into applications so that the applications can be controlled by a script rather than manual interaction from a user. Not all applications typically have TCL embedded in them.

TCL scripting capability (530) is embedded in ViPUL (585). ViPUL commands can be run from TCL script running on ViPUL. For example, to run a ViPUL command “jump n” which suspends current state and make state number “n” get out of suspend state can be embedded in TCL script with TCL command runViPULCommand “jump n”, or vipul::jump “n”

In case the user has instructed ViPUL to control the STDIO from application, TCL script can provided input to the application with “appInput” command

RunViPULCommand “appinput abc wxyz 12345”

Where, string “abc wzyz 12345” is sent to UserApp via STDIN pipe 580 (FIG. 5). STDOUT and STDERR are available to the TCL script via channel “$appStdIO.” The status of UserApp regarding whether it is running, not running or whether the current state has exited is available via variable $vipul_app Status. In case current state has exited, it's exit code is available via TCL variable “$vipul_appExitCode.” Using these variables, most of the typical tasks for controlling user applications can be automated using TCL script. Furthermore, if a debugger (e.g. gdb) is attached to a state, the debugger operation can be controlled via TCL script and a major portion of a debugging task can be completely automated. ViPUL provides TCL scripting capability to applications, which don't have TCL, embedded in them.

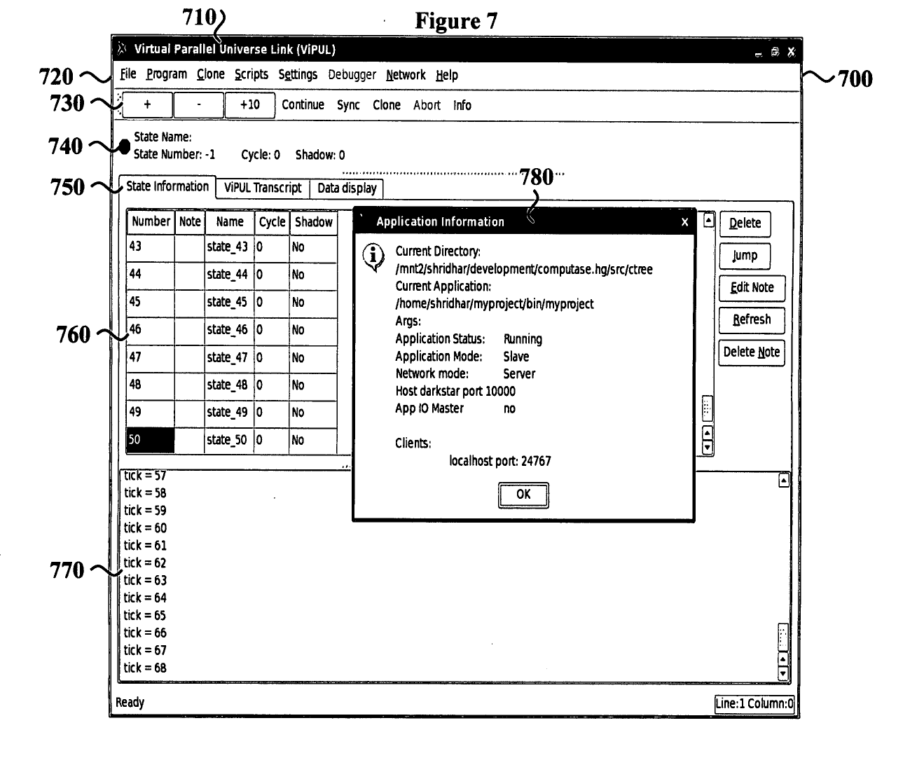

FIG. 7 shows exemplary screen dump of Graphical User Interface (GUI) of ViPUL (700). “Virtual Parallel Universe Link” (710) is main window caption and an example brand name of a computer program build according to the present invention. The menu bar (720) of the ViPUL GUI lists various menus available to the user to interact with ViPUL. Each one of the menus optionally has a submenu. For example “File” menu has submenu items for operations, such as, opening and closing a UserApp, changing current directory, setting up command-line arguments for UserApp, showing ViPUL related windows and debugger related windows and exiting ViPUL.

The first underlined character of the menu is typically used as a shortcut to get to the menu via keyboard keystrokes. Area 730 is a tool bar and has buttons that provide a shortcut to some functionality. For example, when “info” button is clicked, window 780 pops up which summarizes status information about UserApp and ViPUL at that point in time. Widget 740 is a “heart beat” which is a visual cue to the user about ViPUL status. It flashes red if the UserApp is not running, flashes blue if UserApp is running and ViPUL is ready to receive a command, and it flashes yellow if ViPUL is busy processing a command. The ViPUL GUI consists of one or more display areas. For example, screen dump 700 shows a tab area (750) and application STDIO area (770). The tab area (750) has multiple tabs. “State Information” tab shows state table (760), which shows information about all the states of UserApp created by ViPUL. ViPUL transcript tab shows a transcript of all the commands given to ViPUL and corresponding responses. Application STDIO area shows STDOUT and STDERR from UserApp and user can provide STDIN in this areas also. Each one of the display areas has one or more context sensitive menus, which is activated when a mouse button is clicked or a particular sequence of keyboard keys is pressed in a particular display area.

In order to describe one aspect of the present invention as well as its example operation, we will use pseudo-code for simplified examples of typical programs. Pseudo-code is a shorthand way of describing a computer program. Rather than using specific syntax of a computer language, sentences in English are used. Pseudo-code is used to describe the logic of a program. Where appropriate, we will mix pseudo code with C++ style program statements.

TABLE 1
Pseudo-code for a typical program

| T101 //typical.cpp: Pseudo-code for a typical program | |
|---|---|
| T102 // This program is written in C++ style code | |
| T103 #include <sysfile.h> | |
| T104 int main( int argc, char* argv[ ] | |
| T105 { | |
| T106 | int count; |
| T107 | Program Initialization Code |
| T108 | for( int I = 0; I < count; I++ ) |
| T109 | { |

| | |
|---|---|
| T110 | Body of the loop |

| | |
|---|---|
| T111 | } |
| T112 } | |

Table 1 shows pseudo code for a typical application program. Lines T101 and T102 are comments used to document the program and the compiler does not process them. Such comment lines are typically indented to make the code easy to read. Line T103 specifies name of a system header file, in this case “sysfile.h,” whose contents will be inserted in place of the include statement. There may be any number of such “include” directives for system header files and user generated header files. Line T1 04 signifies start of the “main” function within the program, along with return value type and the arguments and their types. This function is called when the OS executes a program written in C or C++. Line T105 signifies start of the body of “main” function and line T1 12 signifies its end. Line T106 defines a variable, called “count” and its type, which is an integer. Line T107 is pseudo code for the initialization portion of the program.

The initialization may be performed using in-line code and/or via multiple initialization routines. Line T108 signifies beginning of a loop, which will be executed for a number of iterations, determined by the value of the “count” variable. Lines T109 through T1 11 are the body of the loop. Although the pseudo-code shown in Table 1 has one loop, a general program may have multiple loops, some of which may be nested. Furthermore, it may have multiple functions, some of which may be nested.

TABLE 2
Example C++ program that generates segmentation fault

| T201 //segf_ault.cpp: Example program that | |
|---|---|
| T202 // Program sets every other element of a[ ] to 1 | |
| T203 // To compile: | |
| T204 // g++ −o seg_fault seg_fault.cpp | |
| T205 int main( int argc, char* argv[ ] ) | |
| T206 { | |
| T207 | int* a = new int[ 5 ]; |
| T208 | for( int i = 0; i != 5; i += 2 ) |
| T209 | { |

| | |
|---|---|
| T210 | a[i ] = 1; |

| | |
|---|---|
| T211 | } |
| T212 } | |

Table 2 shows an example program written in C++, which can be compiled and run on an operating system, such as, Linux or Unix. When run, this program aborts with a segmentation fault. Lines T201 through T203 are comments. Line T204 is also a comment, which gives a command recipe for compiling the program. Line T205 specifies beginning of the function “main” along with its arguments, whereas lines T206 and T212 signify the beginning and the end, respectively, of the function main. Line T207 specifies a variable named “a” of type integer pointer and allocates a space to hold five such integers starting from address “a.” Lines T208, T209, T210 and T21 1 specify a loop, which will be repeated while i is not equal to five. At the end of every loop iteration, i is incremented by two. Line T210 is the body of the loop. The implied intent of this program is to set value equal to one for every other element of array a[i], for i=0 to 4. The programmer made an error and set the limiting condition for the loop to be “i!=5” instead of “i<5.” As a result, the loop does not terminate because “i” never becomes equal to 5. The array “a” was assigned using operator “new” on line T207 to allocate only 5 elements and a[4] is the farthest element that can be accessed. Since the program loop continues to access elements beyond this point, the program eventually aborts with a “segmentation fault,” which means that program accessed memory that has not been assigned to it by the operating system.

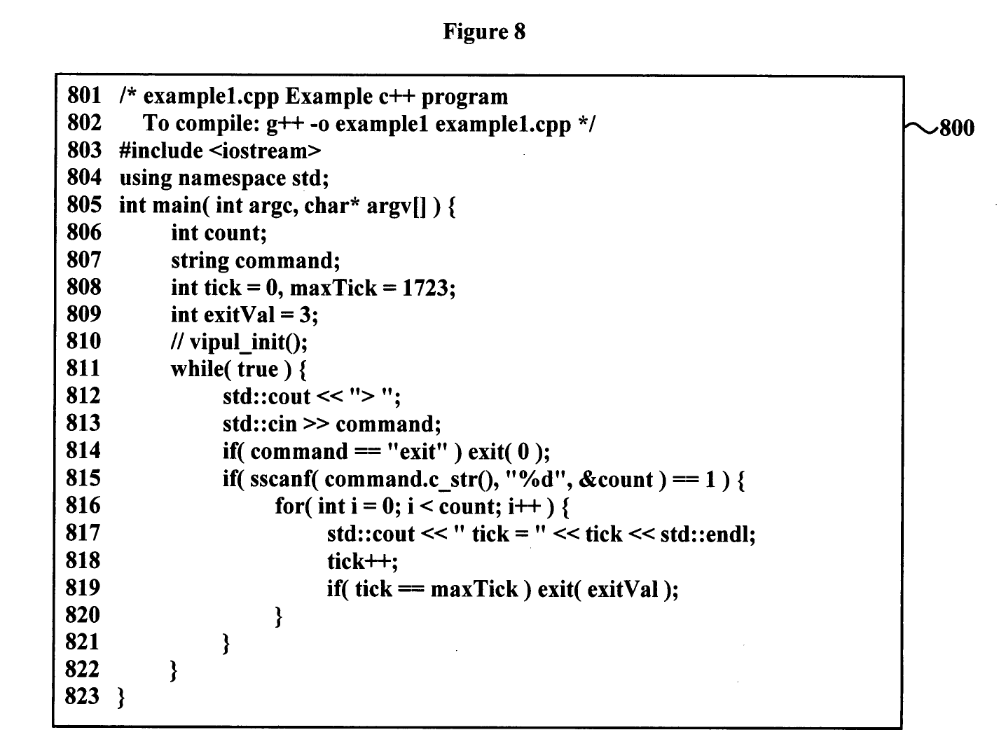

FIG. 8 shows C++ code for an example UserApp (800) based on the code shown in Table 1. While this is a very small complete program, it is includes many elements of a typical program. If LD_PRELOAD mechanism is used to load MgmtSW (420, FIG. 4) line 810 is not needed and hence is commented out. Alternatively, if it is not desirable to load MgmtSW before UserApp, “//” should be removed from line 810 and either ViPUL library containing function Vipul_init should be linked with UserApp, or LD_LIBRARY_PATH variable be set to contain complete path and name of the MgmtSW. UserApp, such as, 800 (FIG. 8) is compiled using a command line given on line 802 and executable “example 1” is stored in computer system 100 (FIG. 1).

As has been pointed out before, a typical program consists of one or more initialization sections and one or more loop sections. We have described how ViPUL sets up asynchronous communication with UserApp using pipes set up in the initialization function. Alternatively, or in addition, UserApp may be modified to include one or more calls to a MgmtSW function Vipul_cycle( ) in other portions. An example placement of a call is in the loop portion of UserApp. The first time Vipul_cycle( ) is called, it sets up a pipe “Sync In” (560, FIG. 5) for sending status, data and responses from UserApp to ViPUL and sets up a pipe “Sync Out” (565, FIG. 5) to send commands and responses from ViPUL to UserApp. This mechanism for controlling UserApp by ViPUL may be used if UserApp does not interact with the user in any way and works from any combination of inputs from command line parameters and one or more input files.

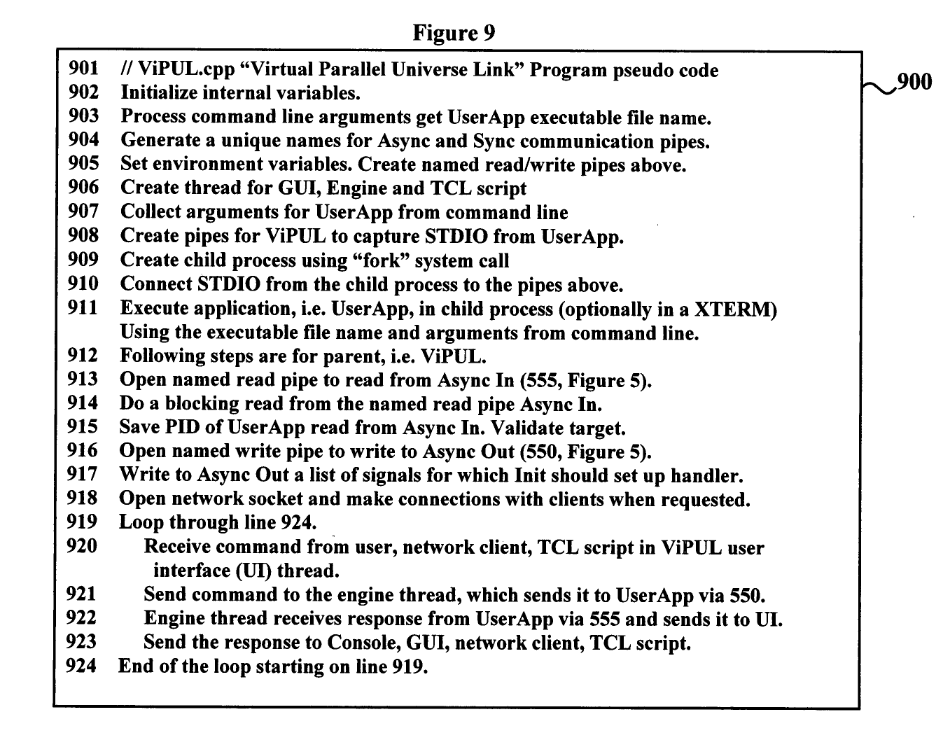

FIG. 9 shows exemplary pseudo code for particular aspects of ViPUL (900) The simulation control program code as illustrated in FIG. 9 is compiled and stored in the computer system 100 (FIG. 1) for execution. Note that one line of pseudo-code in the figures may translate into one or more lines of actual code that may contain multiple nested functions.

Line 901 is a comment. Line 902 initializes internal program variables. Line 903 processes the command line arguments. An example of command line argument is “−h” or “- -help,” which prints ViPUL program usage help message on console. Another example of a command line argument is “−e UserAppExecutable” or “- -exec UserAppExecutable,” which specifies the name of the UserApp executable to be run under the control of ViPUL. Note that, in general, three sets of command line arguments may be specified to ViPUL. First, there are arguments for ViPUL. Second, there may be arguments for UserApp which may be preceded by “- -appargs.” Third, there may be arguments for DbgLib, which may be preceded by “- -dbgargs.

In a general case, LD_PRELOAD mechanism is used to call the initialization function in the MgmtSW while starting to execute UserApp which is used “As Is” without any modification. Thus, there is no built-in mechanism for ViPLUL to communicate names of the named pipes 550, 555, 560 and 565 (FIG. 5) to the UserApp. Base name of these pipes is generated and is set as an environment variable ViPUL_PID (line 904, 905) before UserApp is executed in the child process. The initialization function in MgmtSW uses the value of this environment variable to derive the names of the named pipes, which then match with the names of the pipes generated by ViPUL. Since OS ensures that there is only one process with a given process ID active at any given point in time, this mechanism ensures that the names of named pipes are unique and deterministic for a given instance of ViPUL.

If specified by the user, ViPUL forks a child process in which it executes XTERM, which in turn runs UserApp. In this case the initialization function may be executed while staring both XTERM and UserApp. ViPUL provides option to the user to specify the name of the target executable to which ViPUL should establish communication with. If user specifies UserApp as the final target to control, ViPUL sends a command to the initialization function called while running XTERM to not set up any signal handlers. On the other hand, ViPUL does send a command to the initialization function called while running the specified target UserApp to keep the pipes and set up the signal handlers. The procedure discussed above to establish communication with a specific target process is important in many situations. For example, running a shell or other script, may in turn execute UserApp. In general, there may be a chain of programs that may be executed and one a particular target program ultimately may have to be controlled by ViPUL. Present invention in a general situation may establish communication with all the programs in the chain to control all of them.

Line 905 generates the read and write named pipes, for example by invoking “mkfifo( )” system call. The generation of names of these pipes based on ViPUL_PID is explained above. We will refer to the pipe that UserApp writes to in the signal handler and ViPUL reads from as “UserAppWritePipe” and the pipe that ViPUL writes to and UserApp reads from in the signal handler as “UserAppReadPipe.” Line 905 sets up similar pipes used by UserApp and ViPUL for synchronous communication. As will be discussed below, ViPUL may, optionally use library of functions called “DbgLib” that dynamically attach or detach a debugger to UserApp and provide debug capability via ViPUL user interface. The user invokes ViPUL and specifies the names of UserApp and an optional debugger to run under the control of DbgLib, along with their respective options.”

Line 906 creates threads for GUI, Engine and TCL script in ViPUL. Line 907 selectively prepares the arguments for UserApp. If the user specifies that ViPUL should control STDIO from UserApp it is referred to as “filter” mode. In this case, line 908 creates pipes for ViPUL to capture STDIO from UserApp.

Line 909 forks a child process using “fork( )” system call. A return value of zero indicates the child process, a return value of minus one indicates error and return value greater than zero indicates the parent process, where the return value indicates the process ID “PID” of the child process spawned. Lines 910 and 911 are executed only in the child process. Line 910 connects STDIO from the child process to the pipes if user has selected “filter” mode. It does this by using “dup2( )” system call. Line 911 executes UserApp using, for example, execvp( ) system call. An example of arguments for execvp system call in filter mode is:

Execvp(“example 1”, appArgv);

### Where,

char** appArgv=“example1 arg1 arg2”

An example of arguments for execvp system call when user indicates that UserApp be run in a separate XTERM and ViPUL should not control STDIO is Execvp(“xterm”, appArgv);

### Where,

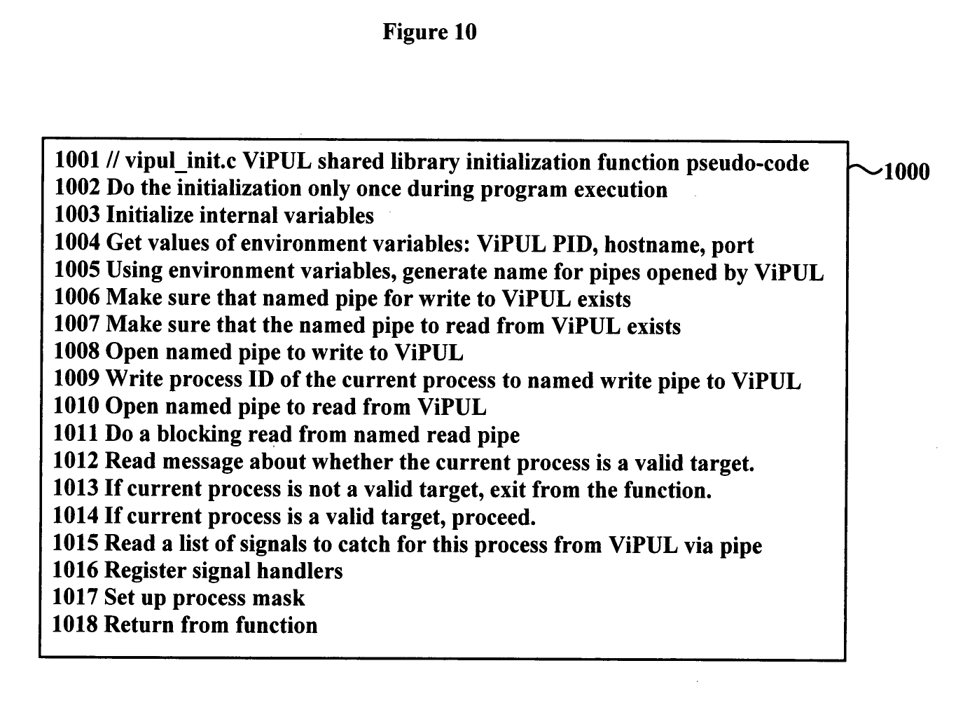

char** appArgv=“xterm −e example 1 arg1 arg2”

Where, “example 1” is the name of UserApp executable and arg1 and arg2 are two command line arguments to the executable “example 1.” At this point example 1 starts running in a XTERM window. A motivation to execute UserApp in a separate XTERM is so the terminal input and output for UserApp and ViPUL are in different windows and it is easier for the user to interact with them. Alternatively, ViPUL may provide a graphical user interface shown in FIG. 7 may integrate UserApp output, ViPUL output and debugger output into a unified view with separate window for each component. The parent ViPUL process only executes statements below line 912. After executing line 911, the child process starts executing the initialization function Vipul_init shown in FIG. 10 and discussed below.

Line 913 opens the name pipe UserAppWritePipe created on line 905 for reading. Line 914 does a blocking read from this read pipe. The parent process blocks on this read until the data becomes available when the initialization function Vipul_init in MgmtSW in UserApp process writes to the pipe as discussed below. Note that the pipes are created on line 905 before the child process is forked. After the child process is forked, the pipes as well as all the file descriptors and other process resources are available to both the child and parent processes on Linux and Unix. Lines 915 through 924 are described below.

FIG. 10 shows pseudo code for function vipul_init (1000) which is run just before UserApp starts running, using LD_PRELOAD mechanism described before. Line 1001 is a comment. Line 1002 sets up variables such that the initialization code in vipul_init is executed only once. Line 1003 initializes internal program variables. Lines 1004 gets environmental variables, such as, ViPUL_PID, which is used to form base name of the named pipes opened by ViPUL as well as hostname and port number if ViPUL set up a network socket before starting UserApp. Using the base name of the named pipes retrieved from environment variable, vipul_init function regenerates the same names to open the pipes such as, UserAppReadPipe and UserAppWritePipe (line 1005). Lines 1006 and 1007 ensure that the named pipes exist.

Line 1008 opens the named write pipe UserAppWritePipe and line 1009 writes the process ID of the current process, i.e. UserApp to the pipe. This write unblocks ViPUL in FIG. 9 at line 914 and as indicated in line 914, the first item read from this pipe is the process ID of UserApp. ViPUL uses this PID to send signals to UserApp. Line 1010 opens the named pipe UserAppReadPipe to read from ViPUL. Line 1011 does a blocking read from this read pipe. UserApp process blocks on this read until the data become available when ViPUL process writes to the pipe as discussed below. Lines 1012 through 1018 are described below.

After reading the pipe on line 914 (FIG. 9), ViPUL uses the PID to find the various attributes from the /proc file system. It compares these attributes with those specified by the user to validate that the process ID that ViPUL is currently communicating with. Line 915 validates the target and sends a message to indicates whether the vipul_init that sent the PID is a valid process that ViPUL intends to communicate with. It opens the pipe 550 and sends the validation status to the UserApp through it (line 916). If the target is valid, ViPUL saves the PID (line 915) of UserApp process, which will be used to send signals to this process via “kill” system call. On line 917 ViPUL sends a list of signals for which the vipul_init function should set up handlers.

On lines 1011 and 1012 (FIG. 10), vipul_init function reads the message written by ViPUL (line 915, 916) via pipe. If the message indicates that the process from which vipul_init sent the PID to ViPUL is not a valid target, vipul_init function registers this fact and returns (line 1013) without doing any further initialization. Otherwise, vipul_init function continues (line 1014). vipul_init function then reads from the pipe (line 1015) a list of signals written by ViPUL on line 917. On line 1016, Vipul_init registers signal handlers for the specified signals.

On line 1017, vipul_init sets up process mask using sigprocmask system call, which examines and changes the blocked signals for the process. On line 1018 vipul_init returns, at which point OS loads remaining libraries specified in LD_PRELOAD environmental variable, calls any other “constructor” functions in these libraries and eventually starts executing UserApp by calling it's “main” function or other equivalent function.

During above handshake process, ViPUL and UserApp optionally exchange a pre-compiled password and encryption of the information sent over the pipes to ensure that UserApp can be run with only a legitimate copy of ViPUL. In addition, ViPUL and UserApp optionally use proprietary or commercial software license manager (e.g., Sentinel License Manager, http://www.pericosecurity.com). Line 918 opens a network socket and makes connection with clients when requested. This step is shown on line 918, but user may specify it any time, either via interactive command or via script. The host name and port number on which this “server” ViPUL is listening for request from one or more “client” ViPULs is set as environment variable. Thus, if UserApp has capability to run script, it may use these variables to establish network communication with the server ViPUL, send commands to ViPUL and receive status and other information from it.

At this point the initialization of ViPUL is complete and it has successfully started UserApp and has established communication with it without a need to change code and recompile UserApp. ViPUL enters a run loop consisting of lines 919 through 924. Line 920 receives a command, which may come from a user interacting with ViPUL via console, a network client or TCL script, etc. On line 921, some commands are processed by the user interface in ViPUL while others are sent to ViPUL engine, which in turn sends them to UserApp using the pipe 550 described above. On line 922, engine thread receives response from the UserApp, processes it and sends relevant information to the ViPUL user interface. ViPUL UI in turn sends the response to the console, GUI, network client and TCL script (line 923). ViPUL goes through the loop comprising lines 920 through 923 until it receives an exit command from the user. Note that the communication mechanism installed by vipul_init in UserApp may send asynchronous messages to ViPUL engine. For example, if a UserApp state calls exit or generates an exception, the associated handlers in MgmtSW send asynchronous message to ViPUL engine over pipe 555. ViPUL engine in turn makes is information available to the UI as well as TCL script running on ViPUL.

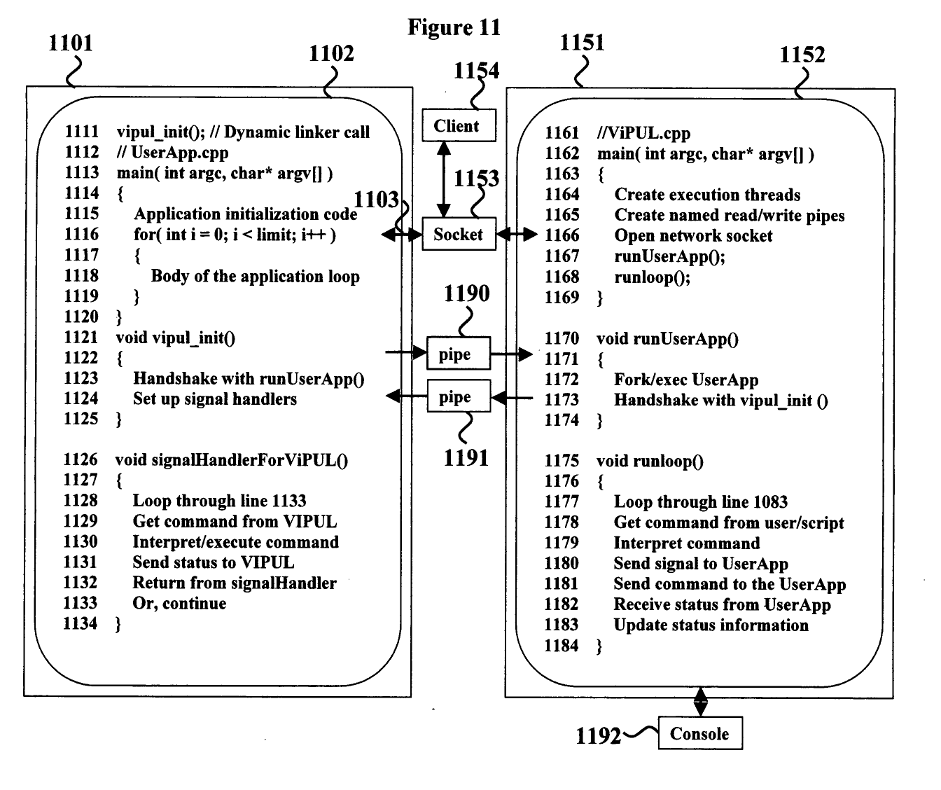

FIG. 11 summarizes operation of ViPUL and UserApp that is described in FIGS. 4, 5, 6, 7, 9 and 10. The user invokes ViPUL (1152) and may optionally direct it to run it in a XTERM window (1151) or in batch mode, i.e. without active user interaction but controlled by a script. Line 1161 is a comment. Line 1162 is the main function within ViPUL. Lines 1163 and 1169 delineate the main function. Line 1164 creates execution threads to provide non-blocking behavior for various functions for ViPUL. Line 1165 creates named pipes for read (UserAppWritePipe, 1190) and named write pipe (UserAppReadPipe, 1191), as indicated by the direction of the arrows. Line 1166 optionally opens a network socket (1153). ViPUL sends the host name of the computer as well as the port number for the socket to UserApp (1102) during the handshake (1173). Optionally, the network socket may be opened when requested by the user, UserApp or script in runloop (1175).

When user instructs ViPUL to execute the UserApp, ViPUL may call function runUserApp (1167, 1170). This function forks a child process and executes UserApp (line 1172) as described in details in FIGS. 9 and 10. UserApp (1102) optionally runs in a separate XTERM (1101). On line 1173 ViPUL opens named pipe UserAppWritePipe (1190) for reading and name pipe UserAppReadPipe (1191) for writing and handshakes with the UserApp as described in details in FIG. 9. Line 1168 calls function runloop, which is listed on lines 1175 through 1184.

Using LD_PRELOAD mechanism described before, OS calls function vipul_init( ) (line 1111). In this function, vipul_int( ) handshakes (line 1123) with runUserApp function (line 1173) in ViPUL on behalf of the UserApp (1102) and without the knowledge of the UserApp. Function vipul_init opens named pipe UserAppWritePipe (1190) for writing and name pipe UserAppReadPipe (1191) for reading. Note that UserApp writes to named pipe 1190 and ViPUL reads from it, whereas ViPUL writes to named pipe 1191 and UserApp reads from it. Note that pipes 1190 and 1191 in FIG. 11 are equivalent to pipes 550 and 555 in FIG. 5.

Function vipul_init sets up signal handlers on line 1124, including one or more signal handler “signalHandlerForViPUL” (line 1126). These signal handlers, in general, process signals received by UserApp, as well as exception cases arising in UserApp. ViPUL sends separate signal to UserApp to execute different class of commands. For example, ViPUL may use one signal to instruct UserApp to clone itself and another signal to suspend itself. The functionality of vipul_init has been described in details in FIG. 10.

When all LD_PRELOAD libraries are loaded and “constructor” functions are called, main from UserApp is executed on lines 1113 through 1120. Line 1115 is the initialization code in UserApp. Lines 1116 through 1119 are example main loop in UserApp. Note that loop on lines 1116 through lines 1119 is for illustration purposes only. According to the present invention, ViPUL can control an application with either no loops or with any number of simple loops or nested loops. Furthermore, the loops may be contained in one or more functions directly or indirectly called from the main function.

If ViPUL was instructed by the user to start a network socket (1153), the host and port information is available to UserApp via environmental variables. If UserApp has scripting capability, the script may contain instructions to use these variables and connect to the socket (1153) as a client (1103). The script may contain instructions to send commands and receive responses via socket (1153) from ViPUL. Alternatively, or in addition, one or more other client ViPUL programs (1154) may connect to the socket (1153). Thus, one or more other users may direct ViPUL remotely.

While UserApp is running, ViPUL is in function runloop (lines 1175-1184). In this loop, ViPUL may receive a command at any point in time from a local or remote user (via network socket), or from a script running on UserApp or from for a script running on ViPUL (line 1178). ViPUL UI interprets the command (line 1179) and may run a subset of commands, such as, “info”, on ViPUL UI itself. To execute other commands, ViPUL UI sends the command to the ViPUL engine, which in turn sends a signal (line 1180) to UserApp and sends the command (line 1181) over UserAppReadPipe (1191). The signalHandlerForViPUL receives the command (line 1129) and interprets as well as executes it (line 1130). It then sends the status and other information to ViPUL (line 1131) via pipe 1190. At this point, depending on the command from ViPUL the signal handler either returns (line 1132) or waits to receive another command from ViPUL (line 1133). ViPUL receives the status sent by the signal handler (line 1182) and updates the information for the user (line 1183) on ViPUL GUI (1192).

A debugger, such as GDB or DDD is a valuable tool in finding coding errors (“bugs”) in a program. A program, which exhibits incorrect behavior, can be run under the control of a debugger, which typically supports source code in various languages, such as, assembly, C, C++, Java, etc. It also provides a mechanism to set up one or more “breakpoints.” If the program happens to execute a line where a breakpoint has been set up, the simulation stops just before executing the instruction(s) corresponding to the line. The program developer can then inspect the values of various variables as well as the logic within the program to determine where the error is. The present invention provides a method to optionally attach a debugger to a particular state of UserApp and provides novel additional functionality to the debugger.

ViPUL is designed to control user applications independent of the language in which they are written. There are numerous computer languages and one or more debuggers are typically available for them. Since debugger functionality is similar across most of the debuggers, ViPUL debugger interface specifies typical functions that are implemented in a shared library “DebugLibrary”. An example of such a function is to instruct the debugger to set a breakpoint at a specified line in a specified source code file. In order to support uncommon debugger functionality, functions are specified to send a command directly from ViPUL via DebugLibrary to the debugger exactly as entered by the user or script. With this specification, a library of functions is developed and compiled into a shared library we will refer to as “DebugLibrary.” Note that ViPUL calls these functions and they send commands to the debugger attached to a particular state.

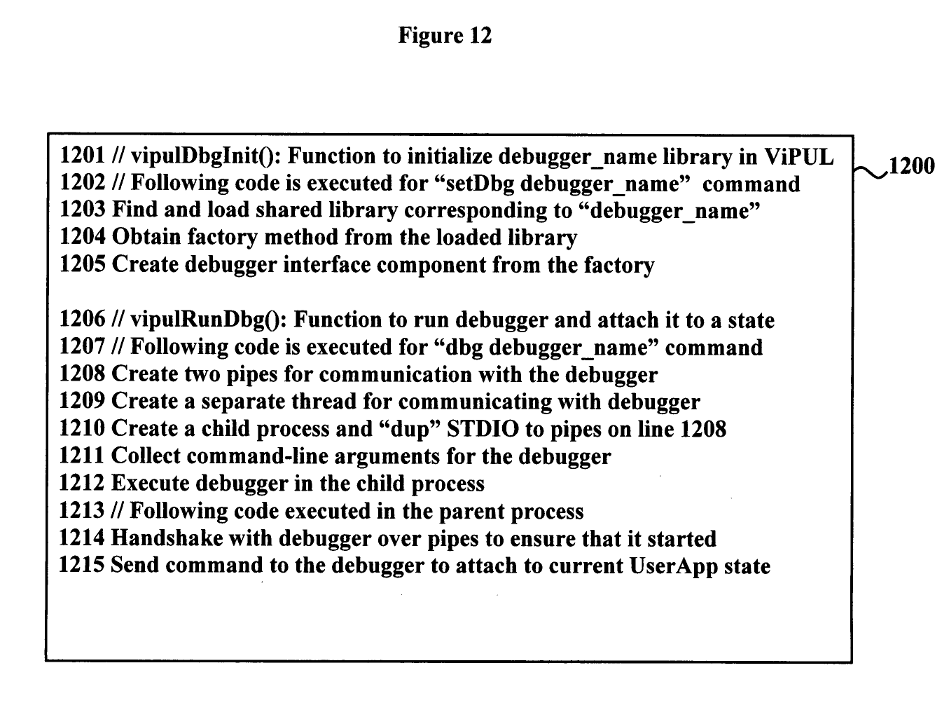

FIG. 12 shows pseudo code (1200) in ViPUL to initialize DebugLibrary and run the debugger. Lines 1201 through 1205 show pseudo-code for function vipulDbgInit, which initializes a debugger interface component, associated with a particular debugger. Lines 1201 and 1202 are comments. ViPUL DbgInit function is called when a user gives “setdbg” command and specifies name of a debugger as argument. Line 1203 finds and loads a shared library, “DebugLibrary” associated with a particular debugger. Example way in which this may be done is for a user to specify it via dialog or via a configuration file. A factory mechanism is used in C++ to load objects at run-time. FIG. 12 shows example code assuming that the DebugLibrary is developed in C++. Line 1204 obtains a factory method from the loaded library. Line 1205 uses this information to make an instance of the debugger interface component on which ViPUL calls various methods in order to communicate with the associated debugger.

Lines 1206 through 1214 show pseudo-code for function “vipulRunDbg,” which runs the specified debugger and attaches it to the current UserApp state. Lines 1206 and 1207 are comments. VipulRunDbg function is called when user gives “dbg” command and specifies name of a debugger as argument. Line 1208 creates two pipes for communication between ViPUL and the debugger using mechanism described before. Line 1209 creates a separate thread for communication between ViPUL and debugger to provide non-blocking behavior. Line 1210 forks a child process and attaches STDIO of this debugger child process to the pipes created on line 1208 using “dup2” system call. Line 1211 collects command-line arguments for the specified debugger, for example, from user at run-time, from ViPUL command-line or from configuration file. Line 1212 executes the specified debugger in the child process.

Lines 1214 and 1215 are executed only in the parent process, i.e. in ViPUL. Line 1214 handshakes with the debugger to exchange any necessary initialization messages and optionally sends commands to the debugger and processes responses to ensure that the debugger is running normally. It then sends process ID and/or any other information about the current UserApp state to the debugger and instructs the debugger to attach itself to that process (line 1215). Gdb debugger provides special “MI mode” for a program, such as, ViPUL to control it via “MI messages.”

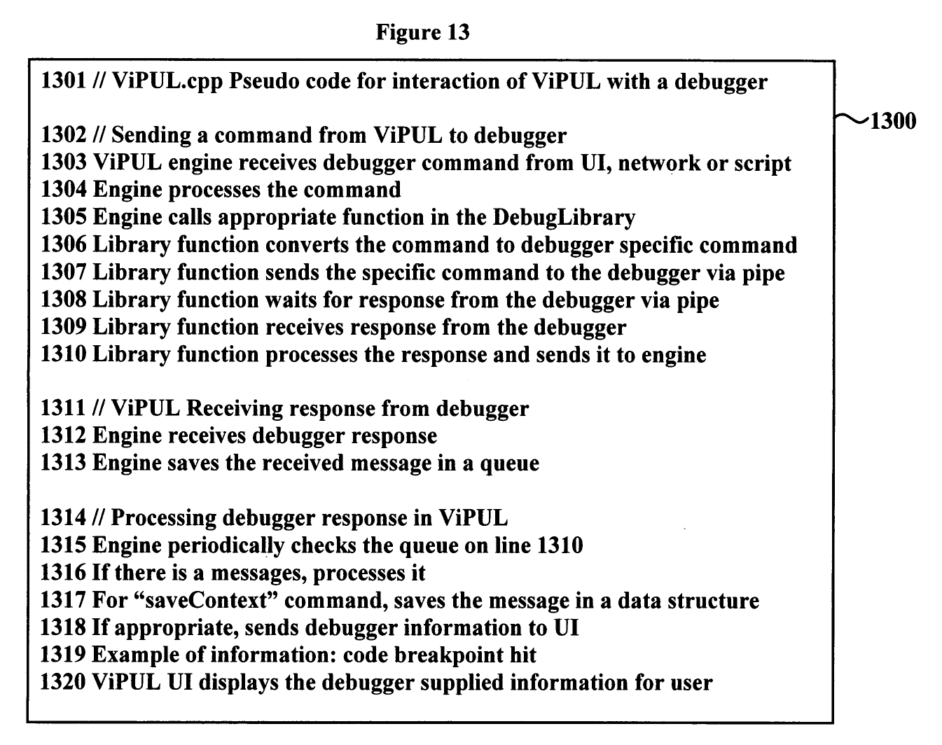

FIG. 13 shows pseudo-code (1300) for interaction of ViPUL with a debugger. Line 1301 is a comment. Line 1302 is also a comment indicating lines 1303 through 1310 show code for sending a command from ViPUL to the debugger. On Line 1303, ViPUL receives a debugger command from multiple sources, such as, UI, network client and a script. On line 1304, engine processes this command and on line 1305 calls appropriate function in DebugLibrary. The library function processes the function parameters and converts them into a corresponding debugger command (line 1306) for the specific debugger and sends it to the debugger via pipe (line 1307) described before. The library receives response from the debugger (line 1309) and processes it and sends the information back to ViPUL (line 1310) either as return parameters for synchronous debugger responses, or via callback functions for asynchronous debugger response.

ViPUL engine receives the debugger response (line 1312) and saves it in a queue (line 1313). Engine thread periodically checks the queue for messages (line 1315). If there is a message, it processes it (line 1316). The engine saves data returned by the debugger in internal data structures (line 1317). If appropriate, the debugger sends relevant information sent by the debugger to UI (line 1318), such as line number and name of the file where the execution has stopped if a breakpoint hit (line 1319). ViPUL UI displays this information for the user (line 1320).

One of the laborious aspects of SW development is the finding and fixing errors in the code, referred to as bugs, introduced by the programmer. In a typical scenario, an error in one part of the code triggers a chain of events which culminates in it's manifestation in code executed in other parts of the program at a later point in time. A typical debug session consists of starting a program (“UserApp”) and observing the erroneous behavior. Subsequently, the program is restarted under the control of a debugger and a breakpoint is set just before the line, which manifests the error. Values of various variables are noted when the program stops at the breakpoint. The real challenge in debugging a program is to determining which one or more lines in the program set one more incorrect value of one or more variables. In this pursuit a programmer may inspect multiple intermediate variables in multiple modules. This process requires restarting the program multiple times. Furthermore, tracing values of various variables involves setting breakpoints in various modules. The debugging process involves going back and forth in time in various modules to zero-in on bug in the code.

Recent versions of gdb debugger (http://www.gnu.org/software/gdb, version 6.5 and later) have a checkpoint and restart feature, which allows a programmer to create multiple states while a program is being run. gdb allows a programmer to restart a saved state. While gdb allows setting breakpoints in the code, it does not provide ability to set state specific breakpoints.

Present invention outlines a method to maintain state specific debug context, consisting of information, such as, code breakpoint, data breakpoint and variables displayed in the debugger. We have already outlined how information about multiple states can be maintained in a state table for UserApp according to the present invention and have outlined a simple user interface for navigating between various states. The present invention specifies a DebugLibrary function to capture the current state of the debugger (“debug context”) and save it in data structures internal to ViPUL on a per UserApp state basis. If a user instructs ViPUL to jump from one state to another state and a debugger is attached to the preset state, ViPUL engine first calls this functions in the DebugLibrary to capture the debug context for the current state. The ViPUL engine saves this debug context in an internal data structure and associates it with the state. It then detaches the debugger from the current state. Subsequently, it sends message to the current state to pause as described before. ViPUL then clears the debugger state by clearing, for example, breakpoints and watch points. It then retrieves the debug context for the target state from internal data structure and sends it to the debugger via DebugLibrary. It then attaches the debugger to the state, which is target of jump command. Finally, ViPUL sends a signal to the target state to exit the pause system call. This provides significant time saving to the user while going back a forth between multiple states while debugging. Furthermore, ViPUL provides commands and GUI widgets to copy partial or complete debug context from one state to another. It also provides methods for organizing debug context in groups, e.g. “user interface code breakpoints” and “Algorithm XYZ code breakpoints.” Furthermore, ViPUL provides method for saving debug context groups in a debug configuration file, which is optionally read by ViPUL.

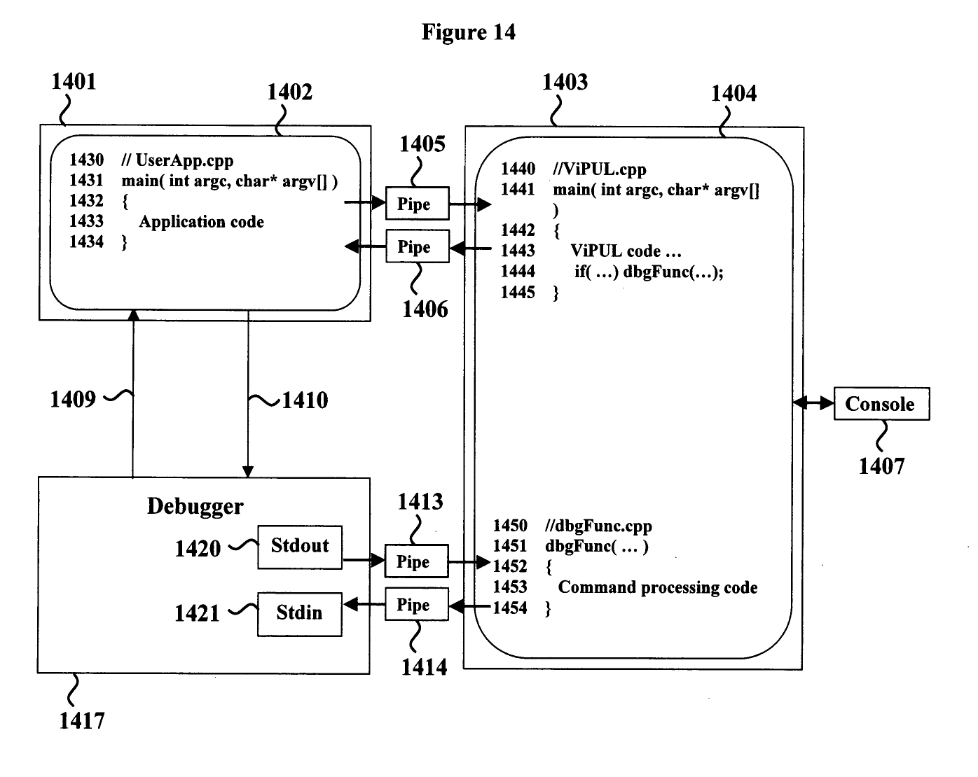

FIG. 14 gives an overview of how ViPUL, UserApp and optionally DebugLibrary as well as the debugger specified by the user interact with each other and with the user at run time. User runs ViPUL (1404), optionally in a XTERM window (1403). Since ViPUL spawns child process and executes UserApp (1402) and the debugger (1417), separate command line arguments may be specified for all three programs. ViPUL forks a child process and runs UserApp (1402), optionally in XTERM 1401. ViPUL and UserApp communicate with each other through named pipes UserAppWritePipe (1405) and UserAppReadPipe (1406). ViPUL receives input from the user via console (1407). Note that the programs may be run in a batch mode, where the user input may be read from input file(s) prepared by the user and the output may be written to output file(s). Similarly, UserApp input and or ViPUL commands may be from a TCL script.

Debugger uses mechanism, such as, replacing instruction in memory by a trace instruction. When the trace instruction is executed, it generates a special signal and a signal handler processes this “breakpoint.” Lines 1409 and 1410 represent debugger controlling the execution of the application using such an exemplary mechanism.

When the user requests to attach a debugger to UserApp, ViPUL loads DebugLibrary corresponding to the debugger as described before. ViPUL executes debug related user commands by calling functions in DebugLibrary. To start the debugger, DebugLibrary forks a child process and runs the debugger (1417) specified by the user. ViPUL and the debugger communicate with each other through pipes DebuggerWritePipe (1413) and DebuggerReadPipe (1414). Note that the debugger is run completely in the background and the user perceives that ViPUL is the debugger, whereas in reality ViPUL is only communicating with the debugger of user's choice via DebugLibrary. Note that DbgLib may provide enhanced functionality over the debugger. For example, for C and C++ debugging, DebugLibrary may provide graphical user interface for GDB debugger with additional features. ViPUL GUI may integrate all the components of FIG. 14 to provide a unified interface to the user. According to present invention, optionally, a single debugger program instance can be used to debug multiple states. This is accomplished while jumping from current state to another state by detaching the debugger from the current state and attaching it to the target state of the jump.

In FIG. 14, lines 1430 through 1434 represent UserApp, lines 1440 through 1445 represent ViPUL code and lines 1450 through 1454 represent a function in DebugLibrary. When user issues a debugger related command, ViPUL code processes it (line 1144) and calls DebugLibrary function, for example, dbgFunc (line 1444). DbgFunc (lines 1451 through 1454) converts the function parameters into a debugger command, which is sent to the debugger process (1417) via pipe 1414. Debugger executes the command by interacting with the application (1409, 1410) and sends the response via pipe 1413. DbgFunc (line 1453) processes the response and return status and optionally any data returned by the debugger to ViPUL (line 1444).

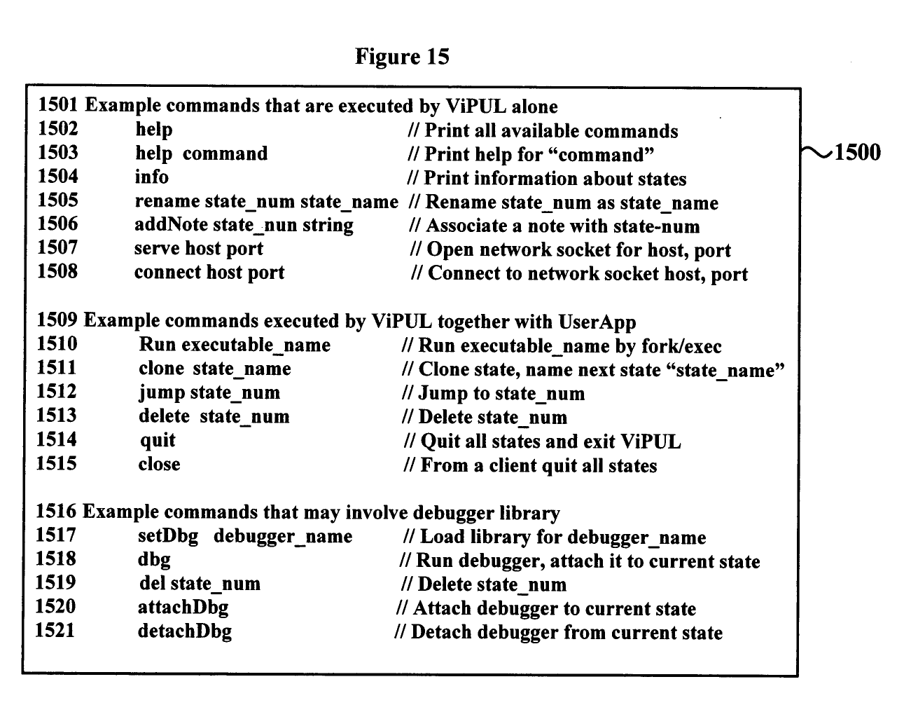

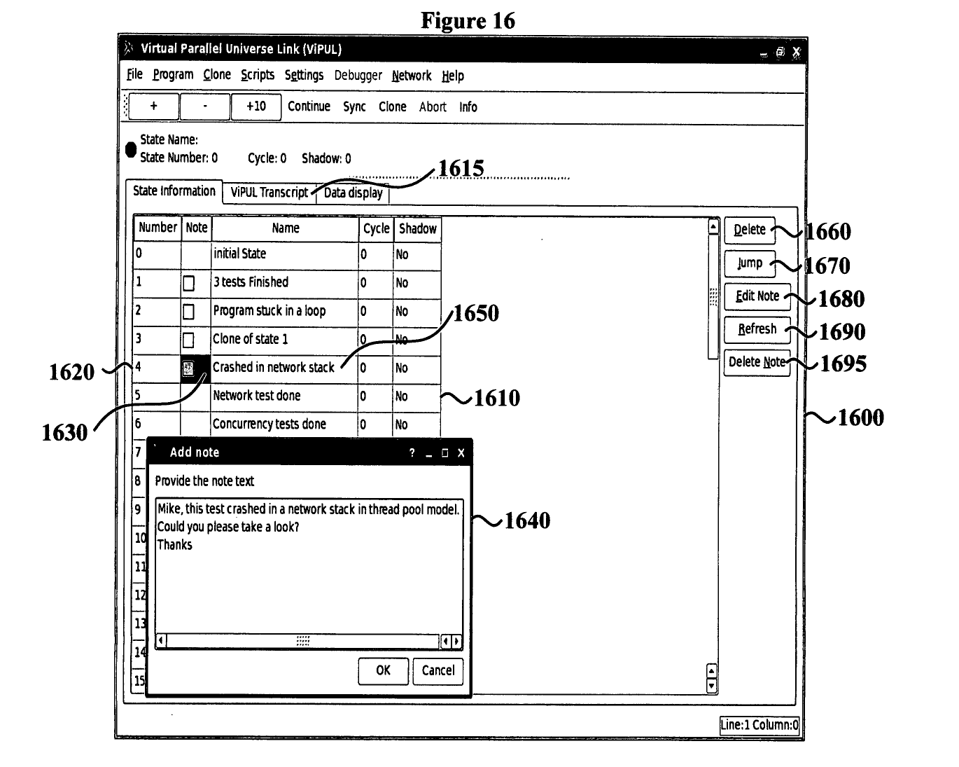

Example ViPUL commands (1500) are listed in FIG. 15. A user may enter these commands via Graphical User Interface shown in FIGS. 7 and 16 through menus, buttons and context sensitive menus. Alternatively, the commands may be entered in an edit box in “ViPUL Transcript” tab (1615).

ViPUL alone may execute some commands (1502 through 1508), it may execute some commands by interacting with UserApp (lines 1510 through 1514) and it may execute some commands by calling one or more functions in DebugLibrary (Lines 1516 through 1521). “Help” (1502) command prints help message on all the available user commands supported by ViPUL. “help command” (1503) prints help for a specific “command.” “info” (1504) command prints state table which is saved while ViPUL controls execution of UserApp and is described below.

To change name of a state, a user may use “rename” command (1505). The command may be issued by double clicking on the state name (1650) at which point the GUI enables editing the name in-place. Using “addNote” command (1506) user may enter and/or edit a note (1630) documenting information and comments related to a state. A note can be entered by double clicking left mouse button in the “Note” area (1630) for any state in state table. This opens a dialog box (1640) where user can enter a note. If a note has already been entered for a state, this is indicated by a yellow square (1630) in the Note column in the state table and double clicking on a note provides opportunity for the user to edit the note.

Serve command (1507) opens a TCP/IP socket on the host on which ViPUL process is running using the specified port number and starts listening on it for a connection request from a client. Connect command (1508) establishes network connection to a server ViPUL to participate in controlling ViPUL remotely.

ViPUL together with UserApp executes example commands 1510 through 1514. Run command starts running “executable_name” i.e. UserApp by doing fork/exec as described in details in FIGS. 9, 10 and 11. “Clone” command (line 1511) creates a identical copy of the current state (process) using “fork” system call as described before, thereby spawning a Virtual Parallel Universe. When ViPUL verifies that the “save” command has successfully been executed, it makes an entry in the state table for the new state and saves “state_name” in it along with other information, such as serial number, process ID and cycle number, which was described above. Jump command (line 1512) instructs the current state to make “sigsuspend” system call and sends a signal to the “state_num” (line 1512), which is the target state, to wake it from the pause state. A user many instruct ViPUL to jump to a particular state by simply double clicking on the state number (e.g. 1620) in the state table (1610). Delete command (line 1513) deletes a state by sending “SIGKILL” signal to the process and ViPUL removes the corresponding entry from the state table. Quit command (line 1514) if issued on the instance of ViPUL which was used to launch UserApp, closes all the open files for all the active states in the state table and sends SIGKILL signal to all of them and exits ViPUL. On the other hand, quit command, if issued from a network client ViPUL, exits while keeping all the states intact. Close command (1515), irrespective of the type of ViPUL instance closes all the open files and all active states in the state table and sends SIGKILL signal to all the processes, but does not exit. Thus, the ViPUL instance is free to run another UserApp or become a client by connecting to a server ViPUL instance.

SetDbg (line 1517), dbg (line 1518) implementations have already been described in FIGS. 12, 13 and 14. del state_num (line 1519) may involve debug library because “state_num” may have debugger context associated with it, which may have to be removed. While executing attachDbg command (line 1520) ViPUL attaches the debugger to the current state, but a debugger has been previously started using setdbg and dbg commands. Otherwise it internally issues these commands before executing attachDbg command. Detach command (line 1521) detaches the debugger from the current state (process) if it is attached.

A state is an UserApp process, which is at a particular point in execution. Each state has user visible attributes maintained by ViPUL and are displayed in a State Table (1610) shown in FIG. 16. The state table has attributes, such as, name (1650), a state identification number (1620) and optional note which is shown as a yellow square, if present (1630). Thus, rather than referring to a UserApp process by PID, user may give it an example name “Crashed in network stack” (1650). Each state may also have user invisible attributes, which are maintained by ViPUL, such as, process ID. ViPUL maintains this information in a list, which is displayed for the user in GUI in a state table (1610). A state table is a navigation center for user to control various states of the UserApp. The state table can also be represented as a tree where the parent and child nodes of the tree represent parent and child relationship between two states. This provides an easy and accurate visualization of time line traversed by the user application.

User can select a state by clicking anywhere on a row in the state table. When a state is selected “Delete” button (1660), “Jump” button (1670), “Edit Note” button (1680), “Refresh” button (1690) and “Delete Note” button (1695) are activated and can be clicked with a mouse to issue corresponding command, where all the commands have been described before and “refresh” command re-displays updated state table. All of these commands are also available as sub-menu entry from the “Clone”

Table 3 shows pseudo-code for the “clone” command run on ViPUL and UserApp. It shows operations carried out by ViPUL in the left column and those carried out by MgmtSW associated with UserApp on the right column. It also shows sequencing of the steps on ViPUL and in the signal handler on UserApp and shows operations carried out with and without a debugger attached to the current state.

TABLE 3
Sequence of steps to execute “Clone” command

| Operations in ViPUL | Operations in UserApp |
|---|---|
| T301. If debugger is attached, get | |
| current debug context from | |
| debugger, e.g. ″info break″ in | |
| gdb. | |
| T302. Get current line number/address | |
| of the current instruction from | |
| debugger, e.g. ″where″ in gdb. | |
| T303. Save information about current | |
| state in state table. | |
| T304. Store command parameters | |
| T305. Send SIGUSR1 to UserApp | |
| T306. Send ″continue″ command to | |
| debugger if it is attached to current | |
| state | |
| T307. Do a blocking read from a pipe to | |
| UserApp | |
| | T308. Enter SIGUSR1 signal handler |
| | T309. Call user supplied “beforeClone” |
| | function |
| | T310 Send handshake signal to ViPUL |
| T312. Receive handshake signal from | T311. Do blocking read from ViPUL |
| UserApp | |
| T313. If debugger is attached to the | |
| current state, detach it | |
| T314. Send command to UserApp to fork | |
| the | |
| current state, send new state number | |
| T315. Do a blocking read from the pipe to | |
| UserApp | |
| | T316. Receive command to fork from |
| | ViPUL via pipe |
| | T317. Make fork system call. |
| | T318. If in parent process after fork, |
| | Make pause system call and wait to |
| | receive a signal. |
| | T319. If in child process, send ok status |
| | along with the PID of the child |
| | process to ViPUL via pipe |
| | T320. Determine all the output files |
| | created |
| | so far and their names and directories |
| | T321. Generate output file names for |
| | current |
| | state. |
| | T322. Flush all output files. |
| | T323 Copy all parent's files to respective |
| | file names generated in 21. |
| | T324. Duplicate old output file descriptors |
| | to new file descriptors |
| | T325 Copy file offset for parent output |
| | file descriptors to new file descriptors |
| | T326. Do blocking read from ViPUL |
| T327. Receive status from UserApp along | |
| with PID of child process | |
| T328. Save information about the new | |
| child process. Copy STDOUT and | |
| STDERR buffer from parent to a | |
| Separate buffer for child. | |
| T329. If debugger was attached to the | |
| saved state, attach it to the new | |
| current state | |
| T330. Set temporary breakpoint at the | |
| point where the previous state from | |
| info in step 2 above | |
| T331. Send continue command to the | |
| debugger | |
| T332. Send handshake message to the | |
| child process, via pipe | |
| T333. Do a blocking read from pipe | T334. Receive handshake message from |
| | ViPUL |
| | T335. Call user supplied “afterClone” |
| | function. |
| | T336. Send handshake message to ViPUL |
| | T337. Restore SIGUSR1 handler |
| T338. Receive handshake signal from | |
| pipe. | |
| “Clone” command is complete | |

In step T309, a user supplied “beforeclone” function is called. In this function user code may optionally do operations, such as, give check in UserApp license. Similarly, on line T335 user supplied “afterclone” function is called. In this function user code may optionally do operations, such as, check out UserApp license. One or more MgmtSW functions may be called to accomplish similar functionality along with or instead of beforeclone and afterclone.

As described before, MgmtSW captures system calls, such as, “open” and maintains a list of base file names and corresponding file descriptors returned by call the system “open” function call. This information is used on lines T320 through T325 for all the output files generated in the parent process up to that point in time to copy them to corresponding files, whose names are derived from the base name and the state number.

If ViPUL is being run in “filter” mode described before, ViPUL allocates a circular buffer to which it copies all the STDOUT, STDIN and STDERR from a given state. During the processing of a clone command shown in Table 3, when a child process is to be spawned, ViPUL creates a new buffer to maintain STDOUT, STDIN and STDERR from the child process and copies the parent's buffer to the child's buffer. When jumping from one state to another state, the output buffer of the current state is always displayed in the appIOTab (770, FIG. 7). Thus, when jumping from 1 current state to target state, finds the PID corresponding to the state number “state_num” that the user wishes to jump to from the list that it maintains and sends signal SIGCONT to that PID using the kill function call. The process corresponding to this PID is in a suspend state when last “clone” or “jump” command was executed by MgmtSW associated with UserApp. SIGCONT gets the process out of sigsuspend system call and the process then sends status “jump ok”, along with the PID of the process to ViPUL for verification. The process corresponding to “state_num” becomes the current UserApp process now active and communicating with ViPUL. All the user commands at this point are sent to this process.

Table 4 shows pseudo-code executed by ViPUL in the left column and that executed by MgmtSW associated with UserApp on the right column. It shows the operation with and without a debugger attached to UserApp. If the debugger, such as GDB, is attached, it is assumed that UserApp is suspended, waiting to receive command either from ViPUL for from the debugger, where latter is provided by the user.

TABLE 4
Sequence of steps to execute “jump” command

| Operations in ViPUL | Operations in UserApp |
|---|---|
| T401 Make sure that the target state_num | |
| Is valid, otherwise give warning and | |
| Flag command to be complete. | |
| T402 If debugger is attached, get | |
| current debug context from | |
| debugger. e.g. “info break” in | |
| gdb. | |
| T403. Get current line number/address | |
| of the current instruction from | |
| debugger, e.g. “where” in gdb. | |
| T404. Save information about current | |
| state. | |
| T405. Send SIGUSR2 to current UserApp | |
| state | |
| T406. If debugger is attached, send | |
| continue command to it. | |
| T407. Do a blocking read from UserApp | |
| pipe | T408. Receive SIGUSR2 signal |
| | T409. Send handshake signal to ViPUL |
| | T410. Makes pause system call and waits |
| | to receive SIGCONT from ViPUL |
| T411. Receive handshake signal from | |
| UserApp | |
| T412. If debugger is attached to current | |
| state, delete the debug context | |
| and detach debugger from current | |
| state. | |
| T413. Restore all the information of the | |
| target state of the jump, including the | |
| process ID, from information saved | |
| for all the states. | |
| T414. If debugger was attached to the | |
| target, access debug context also. In | |
| this case, set up debug context in the | |
| debugger for the target of the jump | |
| command. Set a temporary | |
| breakpoint at the point where | |
| the program was as determined in | |
| step 2 of “save” command. Send | |
| continue command to the debugger. | |
| T415. Send SIGCONT signal to the target | |
| of jump | |
| T416. Do a blocking read from pipe to | |
| UserApp | |
| | T417. UserApp which is target process of |
| | jump receives SIGCONT signal and |
| | enters the handler. Set a flag for |
| | information purpose and restore |
| | SIGCONT handler. |
| | T418. Receipt of SIGCONT makes the |
| | target of jump exit the pause state it |
| | entered in line T318 in “save” or line |
| | T410 in “jump” command |
| | T419. Send handshake signal to VIPUL |
| | T420. Return from signal handler. |
| | T421 The target of jump is now active |
| | process. |
| T422. Receive handshake message from | |
| target of jump UserApp process. | |
| T423. If debugger is attached, the | |
| program runs and stops at | |
| temporary breakpoint. This is exactly | |
| the point where this state was in step | |
| T302 of the “save” command. The | |
| debugger deletes the temporary | |
| breakpoint. | |
| T424. Clear appIOTab and display | |
| The buffer corresponding to that of | |
| The target state. | |
| T425 Command is complete. Target state | |
| of the jump command is exactly at | |
| the point where it was saved in the | |
| “clone” command. | |

The scheme shown in Tables 3 and 4 provides ability for ViPUL to save and restore UserApp states at instruction level granularity if a debugger is attached to the state.

When ViPUL receives “del state_num” command (line 1513, FIG. 15), the user intends to delete state number “state_num.” ViPUL first ensures that state number “state_num” exists the list of states. It then accesses the PID of the state corresponding to the state number “state_num” from this list it marks the entry corresponding to the state number as being deleted. If a debugger has been attached when the “del state_num” command is executed, ViPUL deletes the debug context associated with that process. It then sends signal SIGKILL to the PID, in response to which the OS kills the process. When ViPUL receives “quit” command (line 1514, FIG. 15), the user intends to destroy all the active UserApp processes and quit ViPUL as well as the debugger. ViPUL executes this command by first detaching the debugger from the current state, if it is attached. It then repeatedly executes the “delete” command (line 1513, 1518) for all the states in the list of states that it maintains. Subsequently, it sends a command to the debugger to exit. Finally ViPUL optionally saves any history files and exits.

ViPUL incorporates code to open a TCP/IP network socket and listen on this socket and thereby become a server. It also incorporates code to make a connection with a remote ViPUL and become a client. Thus, the same ViPUL executable can operate either in a server or client mode. Furthermore, ViPUL in a server mode can support simultaneous connections from multiple clients. If the ViPUL server accepts connection from a client ViPUL, then Server and one or more Clients can together control UserApp via ViPUL. Technology, such as, CORBA also offers mechanisms to manage multiple entities. With CORBA, there is no distinction between local or remote object and hence such a multiple client scenario is lot easier to implement. Here we describe a exemplary method based on TCP/IP network socket.

In order to provide all the features of GUI to a remote client, a lot of information must be sent from the server to the client periodically. Some of this information is in form of complex and hierarchical data structures. These are converted to a text stream using, for example, boost serialization library (http://www.boost.org). This stream is sent over the network to the client. On the client, this text stream is converted back to the original data structure.

Table 5 shows pseudo-code run on Server ViPUL in the left column and that executed on Client ViPUL on right to support networking feature. Table 5 also shows a typical time sequence for the operations carried on the Server and Client. Once the server (line T509) has accepted a client request, lines T513 through T525 are typically executed in a loop multiple times, until the client exits. If a server exits while a client is connected, the client is disconnected before the server exits. In client mode all the commands are sent to the server for processing, i.e. ViPUL engine on a client is dormant. The output of a command processed on the server is broadcast to all the clients and is also displayed on the UI of the server.

TABLE 5
Server and Client communication in ViPUL

| Operations on Server ViPUL | Operations on Client ViPUL |
|---|---|
| T501. Start Server ViPUL | |
| T502. Optionally start UserApp | |
| T503. Optionally run user commands | |
| T504. In response to user request open | |
| network socket: | |
| Find an unused port in the user | |
| specified range | |
| Create a server socket on the | |
| specified port and start listening. | |
| T505. Periodically check for connection | |
| Request from client | |
| | T506. Start Client ViPUL |
| | T507. Authenticate: license check and/or |
| | password check |
| | T508. Make connection request to server |
| T509. Server accepts connection | |
| T510. Client authenticates with password | |
| T511. Server sends initialization | |
| information | |
| State table | |
| Current active state | |
| STDOUT buffer for current state | |
| Configuration information | T512. Receive initialization information |
| | from server |
| | Set up configuration |
| | Display state table |
| | Display STDOUT buffer in |
| | AppIOTab |
| T513. Send asynchronous updates | |
| received from engine to all clients | |
| | T514. Receive command from user |
| | Send command to the server |
| T515. Receive command from the Client | |
| T516. Process the command | |
| Locally, or | |
| Send it to ViPUL engine | |
| T517. Broadcast response to all clients | |
| Display response on local UI | |
| | T518. User issues appIOMaster command |
| | T519. Client sends request to Server to |
| T520. Accept the request | to control UserApp STDIN |
| T521. Broadcast to all clients that the | |
| requesting client controls UserApp | |
| STDIN | |
| | T522. User types text in AppIOTab area |
| | T523. Send the text to server |
| T524. Server accepts the text and sends it | |
| to the engine as a parameter to | |
| appInput command | |
| T525 Engine sends the text to UserApp | |
| STDIN | |

As discussed before, when UserApp is run under the control of ViPUL, it may be run in a “filter” mode. In this mode, ViPUL controls the STDIO of the application. The STDIO from the application appears in AppIOTab. This is a window within ViPUL GUI where the STDOUT and STDERR are displayed and the user can type text, which is sent to the UserApp via STDIN, as described on lines T522 through T525 in Table 5.

If one or more ViPUL clients are connected to a ViPUL server, there is a possibility of multiple users typing text in AppIOTab thereby sending undesirable multiple text inputs to the STDIN of the application. To prevent this, ViPUL enforces a method for “application i/o master (appIOMaster),” whereby only one entity among a ViPUL server and one or more ViPUL clients can control the STDIN of UserApp. Any entity can select “AppIOMaster” command (line T518) from “Program” menu (FIG. 7) and become AppIOMaster. When this command is given by an entity, it is transmitted to the server, which in turn broadcasts this information to all the entities. At this point, only appIOMaster is allowed to type in AppIOTab. Attempt to type in this area by other entities in their respective AppIOTab results in a warning and no text is accepted from them.

Conventional computer programs have a large number of lines of code and various modules of the software are routinely developed at multiple locations. When these modules are integrated into a prototype product or final product, it is common to encounter complex bugs that require analysis by team of developers at multiple locations. Present invention provides a novel server/client ViPUL feature described above, whereby developers at multiple locations can participate in the debugging session in progress. This feature is very general and may be used in other situations, for example, a computer game, where a secondary user connects to ViPUL and takes control of the game at previously saved process point.

Furthermore, a ViPUL session may be initiated in batch mode under the control of a script. The script contains code to issue instructions to ViPUL to open a socket and listen on it. The host name and port number are written to a log file specified in the script. A user may subsequently inspect the contents of this log file and use the host and port information to start a ViPUL session in client mode and connect to the ViPUL running in the batch mode. The user may then control the operation of the server ViPUL remotely.

In addition, the user may enter notes for various states and exit ViPUL. Another ViPUL client may then connect to the same server ViPUL running in batch mode and continue the work that the first user did. Thus, present invention enables a user to take control of UserApp started with ViPUL in batch mode. Furthermore, present invention enables transferring the same UserApp session from one user to another user, thereby saving the time, effort and difficulty in recreating a particular condition in the program. Furthermore, multiple users may connect to the same UserApp session running under ViPUL either simultaneously, sequentially or a combination thereof.

In order to provide automatic control over UserApp, ViPUL integrates scripting capability. TCL (Tool Command Language, http://tcl.sourceforge.net) is a popular scripting language. ViPUL supports TCL is two ways. First, ViPUL can run TCL scripts, just like the TCL interpreter. Secondly all the ViPUL commands are exposed to the TCL scripts running under the ViPUL. Additionally information about the running state, such as UserApp STDIO, status and the ViPUL information such as network ports is exposed to the TCL script.

Using these features, a TCL script can completely control a simulation, thereby automating running of UserApp. This TCL support can be used to perform automated regression testing and integrating ViPUL in an existing regression suite. Furthermore, debugger commands can also be issued from the TCL script. Hence a task of debugging a UserApp failure can be partially or fully automated. TCL scripting can also be used to share common execution sections in a workload consisting of multiple instances of running a UserApp. The core of TCL is the tcl library, which it used by all the TCL applications. A program can use facilities provided by this library to integrate TCL. An interpreter object is required to run TCL script. This object acts like a virtual machine in which the TCLscript developed by a user is run. In this interpreter, ViPUL adds status variables as mentioned above and the application I/O as a data stream.

FIG. 8 shows a simple stand-alone, complete C++ program, which is a reduced version of a typical program. Line 801 and 802 are comments and line 802 specifies a command to use GCC compiler to make executable “example1.” Line 803 includes a system header file to use functions for input and output to the console and line 804 specifies that this program uses “std” namespace from iostream. The “main” function for the program starts on line 805 and ends on line 823. Lines 806 through 809 define and initialize variables used in this program. Line 810 specifies a call to vipul_init, which has been commented out. If LD_PRELOAD variable is set this call is not needed. On the other hand, if LD_PRELOAD variable is not set, this function has to be called so various pipes can be set up and communication with ViPUL can be established.

Line 811 is beginning of a while loop which ends on line 822. This code prints “>” as a prompt on the console (line 812) to indicate that the program is ready to receive input from the user (line 813). The program can act only on two inputs. If a string “exit” is entered, it exits with an exit return value zero (line 814). If a decimal integer is entered (line 815), it print “tick=” followed by the current value of the program variable “tick” (line 817), increments “tick” variable by one (line 818) and repeats this for a count equal to the decimal integer entered (lines 816 through 820). After incrementing “tick” variable by one, if it reaches 1723, a value used for illustration purpose, the program exits with exit return value 3 (line 819). If a command other than “exit” or a number is entered, it is ignored.

This simple example program represents a typical interactive application, which prompts the user for some input and generates output based on the input. Furthermore, based on the input, if an internal error condition is reached, typically a program signals this by an exit return value other than zero. It is conventional to return exit return value of zero to indicate normal completion of the program.

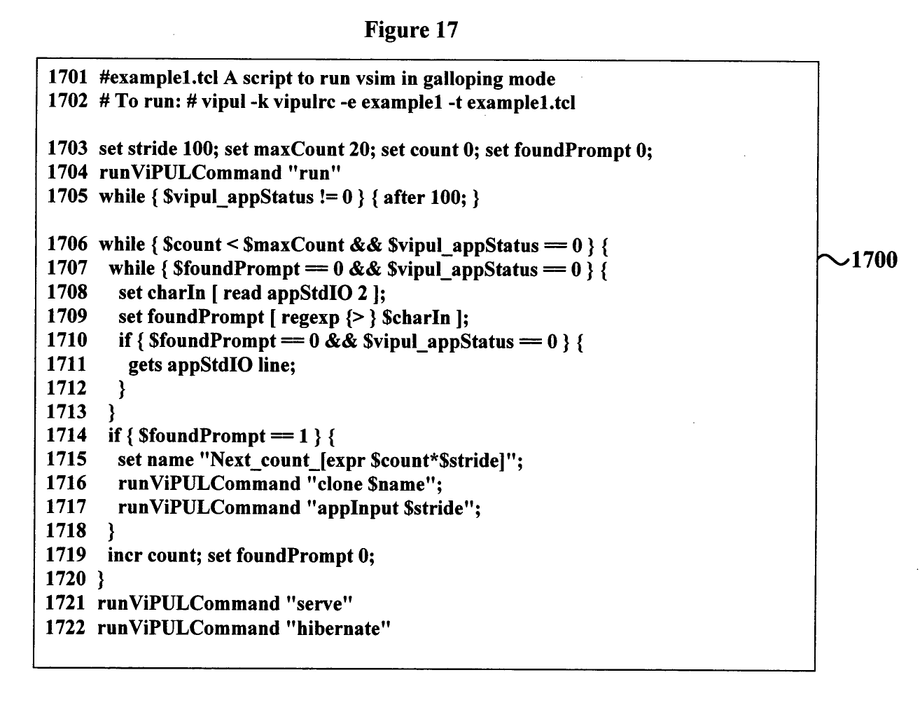

FIG. 17 shows TCL code to control the example application “example1,” c++code for which is shown in FIG. 8 and discussed above. Line 1701 is a comment. ViPUL introduces concept of running a program in “galloping” mode. In this mode, the program is run and a clone state is generated at certain interval. This way, if the program crashes, only that particular state (i.e. process) crashes, while the other states are still available.

Line 1702 shows the command line for ViPUL to run example 1 under the control of TCL script example1.tcl. “vipul” is the name of the ViPUL executable. Argument following −k, “vipulrc” is a name of the file that contains configuration information. Table 6 is a sample listing of vipulrc file.

TABLE 6
Sample listing of vipulrc file

| Line | | |
|---|---|---|
| Number | Entry | Comment |
| T601 | defaultMode = gui | Run ViPUL in GUI mode |
| T602 | style = plastique | GUI display style |
| T603 | ApplicationMode = master | UserApp prompts for commands |
| T604 | AppTarget = example1 | ViPUL controls this program |

Argument following −e option is the name of the executable, which is example1 in this case. Argument following −t option is the name of the TCL script to run on ViPUL, which is example1.tcl in this case. Lines 1703 initializes various variables used in the TCL script. “runViPULCommand” sends string argument to ViPUL. Thus, line 1704 sends “run” command (line 1510, FIG. 15) to ViPUL which instructs it to start running UserApp “example1”. The status of UserApp is available to the TCL script through variable $vipul_appStatus, which takes values APP_NOT_RUNNING (−1), APP_RUNNING (0) or APP_EXITED (1). Line 1705 checks the status of UserApp every 100 ms until it becomes APP_RUNNING.

Lines 1706 through 1720 is a while loop, which is executed while the count is less than 20 and the application is running. Lines 1707 through 1713 is another loop which STDOUT from UserApp available on TCL channel appStdIO and parses for a prompt “>” which indicates that example1 is ready to accept another user command. Line 1715 generates name of a state by appending the next expected value of count to string “Next_count_.” Line 1716 sends “clone” command (line 1511, FIG. 15) to the ViPUL engine which clones the state. Line 1717 sends command “appInput 100” to the STDIN of the application, which sends “100” command to example 1. Line 1719 increments the count by one and the while loop starting on line 1706 executes again if the count does is less than 20 and the application is still running, i.e. has not exited. Line 1721 sends “serve” command (line 1507, FIG. 15) to ViPUL which starts a TCP server on ViPUL and prints the host name and port number on STDOUT. Line 1722 sends “hibernate” command to ViPUL, which has no effect in the interactive mode of ViPUL.

If a “−b logfile” option is specified on the command line 1702, ViPUL run in batch mode. In this case, all the operations are the same as described before, except, that the hibernate command relinquishes ViPUL license and can be instrumented optionally to call a user defined TCL function to check in UserApp (in this case “example1”) line. As a result, ViPUL hibernates along with a various states of UserApp created. In this mode ViPUL as well as UserApp consume negligible computer resources and no licenses. One or more users may start ViPUL instance(s) which can then become a network client(s) using the host name the port number and interact with the server ViPUL instance running in batch mode along with UserApp. It would be obvious to someone skilled in the art to modify the TCL script in FIG. 17 to detect whether program complete normally or abnormally and to issue hibernate command only in the latter case.

Note that example1.cpp shown in FIG. 8 neither has capability to run TCL script nor have multiple users interact with it simultaneously or serially. However, example1 effectively has these capabilities when run under the control of ViPUL. A simple example in FIG. 8 and TCL script in FIG. 17 demonstrates some of the facets of the present invention.

Typically execution time for scientific and engineering computer simulations can be as large as hours, days or weeks and typically consists of running multiple simulations that share common initial portions of execution.

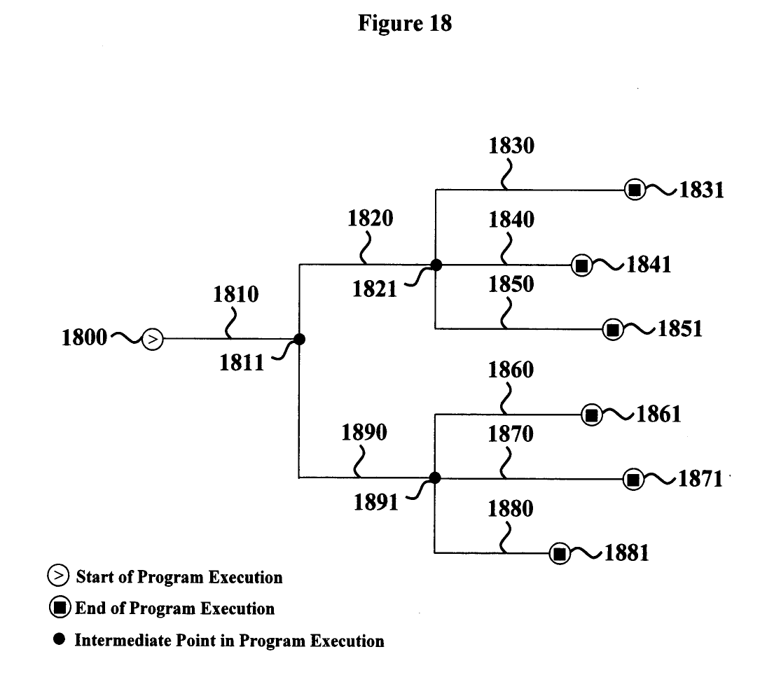

FIG. 18 shows a workload consisting of running a UserApp six times using conditions, some of which are common. For example, one execution run starts at 1800 and executes using stimuli and execution portions 1810, 1820, 1830 and ends at 1831. Another simulation starts at 1800 and proceeds using stimuli and execution portions 1810, 1820, 1840 and ends at 1841. These two execution runs have execution portions 1810 and 1820 in common. Using current state-of-the-art, the six instances of the program in the workload shown in FIG. 18 will have to be run separately. If we represent TNNN as time taken to process stimulus and execution portion NNN, the total time to run six separate instances of programs would be:
6T1810+3T1820+3T1890+T1830+T1840+T1850+T1860+T1870+T1880

If ViPUL was used to control the same UserApp, a TCL script, similar to the one shown in FIG. 17 could be written to share common portions of execution. For example, after processing stimulus 1810, at point 1811 (where UserApp may prompt for input, or some other internal event is detected via synchronous communication with UserApp as described below), a clone command is issued. Stimulus 1820 is given to the parent process and stimulus 1890 is given to the child process. At point 1821, clone command is issued two times. The parent process and two child processes are given stimulus 1830, 1840 and 1850 respectively. These three processes end execution at points 1831, 1841 and 1851 respectively. The execution of processes completing at points 1861, 1871 and 1081 is completed in a similar way. The time to complete the workload of six programs under the control of ViPUL in this scenario is:
T1810+T1820+T1890+T1830+T1840+T1850+T1860+T1870+T1880+5[ViPUL overhead]

Total time in saving is:
5T1810+2T1820+2T1890−5[ViPUL overhead]

ViPUL overhead consists of time for fork system call which is ˜300 microseconds and if T's are of the order of

minutes, the ViPUL “overhead” for clone can be ignored. The overhead also includes time to process the script, if it is use, and it may be negligible.

The present discussion assumes that the application prompts the user for input and the user or a script may use this information to issue “clone” command. However, there are many applications, which do not prompt the user for input and proceed from start to finish with the input supplied in the beginning or the input the application reads from one or more files. ViPUL library provides vipul_cycle( ) function which takes an integer as an argument, which servers as an identifier. This function is inserted in various parts of the code in UserApp, with appropriate value for the identifier. When this function is called, it sends a message to ViPUL over the pipes (460, FIG. 4) and passes the identifier to ViPUL. At run-time, the user specifies the action to take when vipul_cycle( ) is called with a particular identifier. An example is to ignore the call certain number of times and on the next call to clone the state. This approach needs modification to the UserApp and its recompilation. Another approach is to attach a debugger and use breakpoint feature of the debugger to provide similar functionality. This approach requires that the UserApp be compiled with appropriate compiler options so the debugging information, including symbol table, is generated.

The state table (1610) shown in FIG. 16 provides convenient visualization of various processes of UserApp maintained by ViPUL. The state table can display created states in a tree showing parent/child relationship and provides a simple way to group the states and manage them as a group to delete them, add notes, etc.

To run ViPUL, a valid license is required. This license is provided by Computase and limits the use of ViPUL to a stipulated period. The license information includes the customer name and the license expiry date. The plain text contents of the license are also stored in encrypted and hashed form in the license file. This portion of the license file is used for verifying the license. The network connection in ViPUL are encrypted and only a ViPUL process with a valid license can connect to the ViPUL server. Each of the messages passed between client and server is encrypted with a password. This password is authenticated while making a new connection.

For someone skilled in the art, it would be obvious to modify ViPUL to provide ability to control multiple distinct Application Programs from within a single ViPUL session. Various data structures in ViPUL will have to be replicated and the GUI, if available, would open separate windows and separate state table tab for separate applications. In this way, a computer system may have only one license of ViPUL but could run multiple UserApps.

For someone skilled in the art, it would also be obvious that functionality offered by ViPUL may be integrated in the operating system code eliminating a need for a separate ViPUL program. Such an OS facility clearly falls within the scope of the current invention.

We have described the implementation for Linux and Unix operating systems. As pointed out before, the present invention could be implemented on other operating systems using combination of available system calls and user developed system calls. For example, a Unix like system call library is available for Microsoft Windows operating system (UWIN, http://www.usenix.org/publications/library/proceedings/usenixnt97/full_papers/korn/korn.pdf, also Cygwin is a Linux-like environment for Windows, available at the URL of http://www.cygwin.com). Similarly, the present invention is not restricted to applications written in C or C++. Most languages support calls to functions written in C or C++, hence functions in MgmtSW may be used. Alternatively, functions similar to those in MgmtSW can be developed in the required language.

A program like ViPUL built according to the present invention may be used in many ways to control UserApps in wide variety of fields to efficiently solve wide variety of problems. One example is a computer run-time environment for running 0programs so that if they crash, one or more earlier states are guaranteed to be saved in galloping mode. In case of such a crash, a user may recover the earlier state and either continue the program execution with the same or different stimulus. Alternatively, the user may debug the cause of the crash using the investment in time and computer resource to run and save intermediate states. The product may be used to save states periodically either for documentation purposes or for recovery in case of program crash.

Another example usage of ViPUL is as a computer run-time environment product for running multiple instances of a program so that the total execution time for running the programs is reduced. This usage is described in FIG. 18.

Another example usage of ViPUL is to enables user one or more opportunities to change the stimulus they provided to the program. For example, it may be used to let user go back to certain point in playing a computer game and continue with the same or different stimulus. ViPUL may offer fault tolerance in embedded systems by providing ability to revert back to a saved state when the program crashes.

Another example usage of ViPUL is as a debugger product that provides a capability to run simulation either forward or backward in time. It also provides ability to attach a debugger of user's choice to a particular state of the program, along with the debug context. Such a product would also enable the user to capture all the inputs that lead to the program failure without having to restarting the program execution from the beginning. Existing commercial debugger may be interfaced with ViPUL according to the present invention.

The foregoing description of ViPUL is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A computer-implemented method of controlling execution of an application program on operating system of a computer comprising:
initiating execution of a control program; said initiating creating a control process;
initiating execution of said application program; said initiating creating an application process;
loading a management software in said application process; said management software communicating with said control process; and
said application process executing one or more control commands issued by said control process.

2. The method defined in claim 1, further comprising
trapping one or more system calls made by said application process;
processing said one or more system calls; and
passing said one or more system calls to said operating system.

3. The method defined in claim 1, further comprising:
sending one or more signals to said application process; and
provisioning handlers for said signals.

4. The method defined in claim 1, wherein said operating system
provisioning said communicating using one or more of operating system signals, operating system network pipes operating system sockets and means of interprocess communication.

5. The method defined in claim 1, wherein said initiating execution of said control program is performed by said operating system without user intervention.

6. The method defined claim 1, further comprising:
creating a plurality of instances of application processes by initiating execution of a plurality of additional instances of said application program; and
management software in said plurality of additional application processes selectively and concurrently communicating with said control process; and
said processing said control commands sent by said control process.

7. The method defined in claim 1, further comprising spwaning a plurality of identical copies of said application process using a spawn control command to create a plurality of copy processes; and
suspending execution or continuing execution of said identical copy process or said application process.

8. The method defined in claim 1, wherein said management software, upon receiving said spawn control command, duplicating output files in said copy process of said application process.

9. Method defined in claim 3, further comprising:
suspending execution of said application process, said suspending responsive to a suspend signal received by said application process.

10. The method defined in claim 3, further comprising:
resuming execution of said application process, said resuming responsive to a resume signal received by said application process.

11. The method defined in claim 1, further comprising said management software trapping said application process terminating and recording cause of termination;
and said management software communicating said recorded cause to said control program process and upon receiving a said control command from said control program either suspending execution of said terminating application process or continuing with said application process terminating.

12. The method defined in claim 1, wherein said control process further implements the step of: capturing console output generated by said application process or providing console input to said application process.

13. The method defined in claim 1, wherein said control process further implements the step of: executing in interactive mode or batch mode.

14. The method defined in claim 1, wherein said control process further implements the step of communicating with one or more users using one or more user interfaces to receive one or more user commands and processing said user commands.

15. The method defined in claim 1, wherein said control process further implements the step of provisioning to run a script to partially or fully automate operation of said control process.

16. The method defined in claim 1, wherein said control process further implements the step of provisioning to open a network socket to partially or fully operate said control process remotely over a network.

17. The method defined in claim 7, further comprising
presenting said application process or said plurality of copy processes as a plurality of states of said application program at a plurality of points in time in execution of said application program; each of said plurality of states characterized by one or more of: an identification number, an editable name or an editable note.

18. The method defined in claim 17, further comprising:
provisioning a user command to jump from a current state to a specified target state by sending said suspend signal to said application process corresponding to said current state and sending a resume signal to said application process corresponding to said specified target state.

19. The method defined in claim 18, wherein said control program further implements the step of provisioning means to attach a debugger to said state and provisioning user interface to control operations of said debugger.

20. The method defined in claim 19, wherein said control program further implements the step of provisioning means to save debug context associated with said state, comprised of breakpoints, watch points or display variables active in said debugger.

21. The method defined in claim 20, wherein said control program further implements the step of provisioning, during execution of said jump user command, means to save said debug context for said current state and restoring said debug context for said target state.

22. A computer apparatus for executing application program code on a computer system comprised of hardware and an operating system, wherein said computer apparatus comprising a user interface for controlling execution of an application program by:
initiating execution of a control program; said initiating creating a control process;
initiating execution of said application program; said initiating creating an application process; loading management software in said application process; wherein said management software: communicating with said control process; and said application process executing one or more control commands issued by said control process.

23. A computer program product comprising a recordable media, including a computer readable program, wherein the computer readable program when executed on a computer causes the computer to execute a method of controlling execution of an application program; said computer program product comprising: computer usable program code for initiating execution of a control program;
said initiating creating a control process; computer usable program code for initiating execution of said application program; said initiating creating an application process;
computer usable program code for loading a management software in said application process; said management software communicating with said control process; and said application process executing one or more control commands issued by said control process.
